(19) United States
(12) Patent Application Publication
(10) Pub. No.: US 2017/0004567 A1
(43) Pub. Date: Jan. 5, 2017

(54) SYSTEM AND METHOD FOR PROVIDING MODULAR ONLINE PRODUCT SELECTION, VISUALIZATION AND DESIGN SERVICES

(71) Applicant: DIMENSIONALMECHANICS, INC., BELLEVUE, WA (US)

(72) Inventors: RAJEEV DUTT, REDMOND, WA (US); CATALIN ALEXANDRU NEGRILA, REDMOND, WA (US); SHAE HURST, WOODINVILLE, WA (US); DAVE HEBERT, MIDDLETON, IN (US); SUSANNAH THOMPSON, MERCER ISLAND, WA (US); JASON K. ELLIS, KIRKLAND, WA (US)

(21) Appl. No.: 15/198,553

(22) Filed: Jun. 30, 2016

Related U.S. Application Data
(60) Provisional application No. 62/187,451, filed on Jul. 1, 2015.
(60) Provisional application No. 62/243,513, filed on Oct. 19, 2015.

(51) Int. Cl. G06Q 30/06; G06Q 50/00

(52) U.S. Cl. CPC G06Q 30/0643; G06Q 30/0631; G06Q 50/01

(57) ABSTRACT

Systems, apparatuses, and methods for generating an on-line/eCommerce based garment viewing, selection, and sizing service that includes a virtual shopping experience capable of being initiated by activating an embedded uniform resource locator (URL) from an arbitrary web-based application or browser. The inventive system includes elements and processes that may be used to generate realistic images and behavior of a user's digital facsimile and associated clothing and/or accessories under different environmental viewing conditions (such as lighting, shading, etc.). These elements and processes may include mathematical/computational models of fabric appearance at both larger and smaller scales, fabric motion under conditions of wind or movement of a person wearing a garment, fabric reflectivity, garment seams, stylistic elements, etc. Models of a person generated by use of the inventive system may include consideration of one or more of a user's height, weight, age, skin tone, fitness level, hair, hair style, makeup, etc.

### CROSS REFERENCE TO RELATED APPLICATIONS

This application claims the benefit of U.S. Provisional Application No. 62/187,451, entitled “System and Method for Providing Modular Online Product Selection, Visualization and Design Services,” filed Jul. 1, 2015, which is incorporated by reference herein in its entirety (including the Appendix) for all purposes. This application also claims the benefit of U.S. Provisional Application No. 62/243,513, entitled “System and Methods for Characterizing a Fabric or Material,” filed Oct. 19, 2015, which is incorporated by reference herein in its entirety (including the Appendix) for all purposes.

### BACKGROUND

Product returns are a major source of overhead for a business, requiring administrative, customer relations, and other employee time, as well as equipment and the use of resources that might be more optimally used for other purposes. The scale of this issue is demonstrated by an estimate that as much as ⅓^{rd} of online purchases are returned or exchanged, resulting in a substantial cost to the retailer. As noted, this can be a significant source of operating overhead (including direct costs, employee time, use of internal inventory management resources, and administrative or management time), particularly for products that require inspection and/or restoration/maintenance prior to restocking.

For example, in the area of apparel, returned items may require inspection, repair, cleaning, sanitizing, and/or pressing before being able to be returned to a sales floor. Further, because of differences between sizing (i.e., non-uniform sizes, “vanity” sizing, etc.), manufacturing methods, design elements, and fabrics among clothing, it may not be possible to know how well a particular item of clothing will look and/or fit until it is tried on and closely examined. This may lead to customers ordering multiple styles and sizes of items, with the intention of returning the majority of them. Not only does this require that the merchant expend resources to return the items to a sellable condition and place them back on the sales floor (or in a local or global inventory), but also removes those items from being available to other customers until they are returned and processed. Thus, the overall cost of processing returns can be quite significant in terms of actual costs, labor, and opportunity costs.

Reducing the rate and number of returned products would therefore benefit retailers and similar businesses. In the area of garments, one approach to reducing returns has been to provide a shopper/customer with an image or representation of a person or human-like figure wearing the garment (such as a fashion model, animated figure, etc.). This is assumed to provide the viewer with more (and hopefully sufficient) information about the style, color, fit, and overall appearance of the garment. However, this approach does not provide the customer with more detailed information that might enable them to make better decisions with regards to whether the color, fit, or style will look as they desire when worn by them.

Conventional approaches to providing customers with an image or representation of how a garment would appear on the customer generally suffer from one or more disadvantages related to (a) insufficiently realistic appearance of the customer and their body, (b) insufficiently realistic appearance of the garment on the customer's body, (c) insufficiently realistic appearance and behavior of the garment's motion as the customer moves, or (d) insufficiently realistic appearance and behavior of the garment's fabric or detailed features (such as seams, lapels, pockets, etc.). Hence, while useful, the conventional approaches for generating an image or representation of a user wearing a garment are often not adequate for making a purchase decision or understanding how a garment would appear under different environmental conditions (such as lighting, rain, different backgrounds, eta). Further, many of the conventional approaches require specialized hardware located on a retailer's premises (such as body scanners or a virtual reality headset); this may be sufficient for some customers but not for those attempting to select an item of apparel using an eCommerce website.

In addition to return processing (and the attendant costs and need for administrative resources), one of the major concerns or challenges for designers, manufacturers, and retailers is the required time to market for time-critical designs, such as apparel, furniture, seasonal items, special “trial” items, items linked to a specific event, promotional items, etc. A possible problem in such cases is that without adequate context, a product may be created without actually verifying (or being able to verify) that it looks good on a real person or in a realistic environment. As designers are time (and resource) constrained, they typically cannot perform this verification in the real world, and as a result, there are many mistakes made in manufacturing and distributing clothing and decorative items that do not fit or appear as intended (and hence may not sell well enough to generate a suitable profit). However, using an embodiment of the inventive system and methods and with accurate physical models of both the person and the garment, a designer can “test” evaluate the garment, furniture, or other item before sending it out to be manufactured.

Another challenge facing designers is that currently, designers have to go through a broker to sell their products to a customer, as a designer on his/her own will not have the resources to create prototypes and experiment with different fabrics etc. In this case, the designer loses out because the broker will typically take a relatively large cut of the design's value because of the risks that the broker takes. However, using an embodiment of the inventive system and methods, a designer is provided with the tools to visualize the product as well as select/exchange materials without having to create prototypes, because the simulation is handled by the invention. As a result, a designer can sell directly to the customer without having to go through a broker. Note that to enable this scenario, realistic product and environment simulations are necessary.

Conventional approaches to generating such visualizations or simulations typically suffer from a lack of emotional connection between a viewer/shopper or potential retailer and the garment or other item. Many of the solutions on the market today appear unpolished, more suited to a video game, or gimmicky,

Embodiments of the inventive system, apparatus, and methods are intended to address and solve these and other problems or disadvantages with conventional systems and methods, both individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are directed to systems, apparatuses, and methods for generating an on-line/eCommerce based garment viewing, selection, and sizing service that includes a virtual (and in some instances, social) shopping experience capable of being initiated by activating (i.e., selecting or launching) an embedded uniform resource locator (URL) from an arbitrary web-based application or browser. The inventive system and methods include elements and processes that may be used to generate more realistic images and behavior of a user's digital facsimile and associated clothing and/or accessories under different environmental viewing conditions (such as lighting, shading, etc.) than conventional systems. These inventive elements and processes may include mathematical/computational models of fabric appearance at both larger and smaller scales, fabric motion under conditions of wind or movement of a person wearing a garment, fabric reflectivity, garment seams, stylistic elements, etc.

Models of a person generated by use of the inventive system may include consideration of one or more of a user's height, weight, age, skin tone, fitness level, hair, hair style, makeup, etc.

Note that the concepts described herein can be extended to any other sellable object that may benefit from or requires context and visualization, such as furniture, decorative objects, jewelry and shoes. The invention can be used as part of the design, selling, and support of real-world objects by enabling visualization and modification in real-time, where an example of a modification might include changing materials or form.

In one embodiment, the invention is directed to a system for generating a visualization of a shopper wearing a garment, where the system includes:

an electronic commerce platform operated for the benefit of a source of a plurality of items of apparel, wherein the electronic commerce platform includes elements configured to
generate a user interface for use by the shopper, the user interface including a selectable element which, when selected or activated, initiates a process coupling the electronic commerce platform to a visualization service platform; and
provide access to an electronic catalog or other set of data describing the plurality of items of apparel;

a visualization service platform, wherein the visualization service platform includes elements or processes configured to
authenticate the shopper;
access data describing the shopper;
if necessary, request data describing the shopper;
receive data identifying an item of apparel from the electronic commerce platform;
in response to receiving the data identifying the item of apparel, access data describing the material from which the item is constructed and the structural elements of the item of apparel;
generate an electronic representation of the item of apparel;
generate an electronic representation of the shopper wearing the item of apparel;
generate a visualization of the shopper wearing the item of apparel;
present the visualization of the shopper wearing the item of apparel to the shopper;
receive an input from the shopper identifying a change to the environmental conditions associated with the visualization of the shopper wearing the item of apparel; and
re-generate the visualization of the shopper wearing the item of apparel in the changed environmental conditions.

In another embodiment, the invention is directed to a method of enabling a shopper to conduct a purchase transaction for an item of apparel, where the method includes:

providing a computer implemented process to enable the shopper to select the item of apparel;

providing a computer implemented process to access data regarding the item of apparel from an electronic data storage element, wherein the data regarding the item of apparel includes data that represents the response of a material from which the item of apparel is at least partially constructed to an applied force or data that represents the appearance of a material from which the item of apparel is at least partially constructed in response to a source of illumination;

providing a computer implemented process to enable the shopper to construct a visualization of the shopper based on physical characteristics of the shopper;

generating a visualization of the shopper wearing the item of apparel;

displaying the visualization to the shopper;

enabling the shopper to vary one or more environmental conditions related to the visualization;

generating a new visualization of the shopper wearing the item of apparel under the environmental conditions as varied by the shopper;

providing a computer implemented process to enable the shopper to indicate a desire to purchase the item of apparel; and

executing a computer implemented process to enable the shopper to initiate a transaction to purchase the item of apparel.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a diagram illustrating an operational environment or computing architecture in which an embodiment of the inventive system and methods may be implemented;

FIG. 2 is a diagram illustrating a possible system architecture that may be used to implement an embodiment of the inventive system and methods;

FIG. 3 is a diagram illustrating an example of certain data that may be exchanged between a retailer/merchant and the service platform as part of implementing an embodiment of the inventive system and methods;

FIGS. 4(a) and 4(b) are flowcharts or flow diagrams illustrating a process, method, operation, or function that may be used when implementing an embodiment of the invention;

FIG. 5 is a flowchart or flow diagram illustrating a process, method, operation, or function that may be used when implementing an embodiment of the invention;

FIG. 6 is a flowchart or flow diagram illustrating a process, method, operation or function that a user may interact with to generate a suitable digital facsimile, generate a model of how a selected garment would appear on that digital facsimile, and enable the user to visualize the selected garment on the digital facsimile in varying lighting or other environmental conditions, and that may be used when implementing an embodiment of the invention;

FIG. 7 is a flowchart or flow diagram illustrating a possible data flow hat may be used when implementing an embodiment of the invention;

FIG. 8 is a flowchart or flow diagram illustrating a rendering pipeline that may be used when implementing an embodiment of the invention;

FIGS. 9-11 are diagrams illustrating components of and methods of using a fabric or material scanner or characterization system that may be used when implementing an embodiment of the invention;

FIG. 12 is a diagram illustrating aspects of a “model” of a body that may be used when implementing an embodiment of the invention;

FIG. 13 is a diagram illustrating a first example architecture for integrating an embodiment of the invention with a vendor's website;

FIG. 14 is a diagram illustrating a second example architecture for integrating an embodiment of the invention with a vendor's website; and

FIG. 15 is a diagram illustrating elements or components that may be present in a computer device or system configured to implement a method, process, function, or operation in accordance with an embodiment of the invention.

Note that the same numbers are used throughout the disclosure and figures to reference like components and features.

### DETAILED DESCRIPTION

The subject matter of embodiments of the present invention is described here with specificity to meet statutory requirements, but this description is not intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that is part of a client device, server, network element, or other form of computing or data processing device/platform and that is programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or any other suitable form. The following detailed description is, therefore, not to be taken in a limiting sense.

Embodiments of invention may include implementation in the form of one or more of a web-based/cloud service platform (provided on an as-used basis or as a subscription service, and to an end user and/or apparel merchandiser or designer), a software implemented application or plug-in, a visualization engine, a design or garment evaluation environment, a garment manufacturing system, etc.

In contrast to conventional approaches, the inventive system and methods focus on the overall workflow for presenting a realistic visualization to a shopper as part of a purchase transaction, and how it may be improved or facilitated. The increased degree of realism provides a shopper with a much stronger connection to what they are buying as well as an investment in keeping up their digital facsimile(s). Attracting younger shoppers is another challenge faced by designers and retailers. By creating a digital facsimile that can be modified and/or improved upon and made to look more realistic, the inventive service encourages an emotional investment in the digital facsimile and the retailer who supports it. Note that possible customizations include, but are not limited to: body shape, body fat/muscle ratio, skin color, hair color, hair type (straight, wavy, curly), hair style, eye color, face, facial or body hair, presence of a tattoo, etc.

In some embodiments and use cases, the inventive service will reduce return rates and the related costs by allowing a user to visualize themselves wearing a particular outfit (with or without accessories such as shoes, jewelry, handbags, hats, etc.). Moreover, in some embodiments, the user may invite friends into the virtual retail experience to enable a discussion or chat regarding the apparel, and thus to obtain the opinion or evaluation of others. This “social networking” aspect of embodiments of the inventive system and methods may also be used to examine the respective wardrobes (in whole or in part) of the customer and/or their friends in order to generate suggested combinations, recommended items, identify desirable colors or combinations of outfits, apply machine learning or collaborative filtering techniques to generate recommendations or identify members of the social network having similar style or tastes, etc.

In some embodiments, the inventive service platform can be used by a garment designer/retailer and can be launched from a web page or online application capable of using a RESTful interface (Representational State Transfer: a software architecture style consisting of guidelines and best practices for creating scalable web services, although embodiments of the invention may also or instead be implemented in accordance with other formats, rules, or paradigms), and allows a user to see a virtual representation of themselves wearing a virtual version of a garment that the user is considering buying (or simply wants to view themselves wearing). In some embodiments, the virtual representation may have very similar body proportions and appearance to the user. As noted, embodiments of the invention also provide a service whereby a user can invite friends into a virtual changing room to ask their advice on an outfit (a virtual social retail experience).

Note that a virtual garment generated by an embodiment of the invention will have properties (e.g., light reflection, appearance, fabric type, fabric motion, etc.) that are closely representative of the actual physical garment and of its appearance and movement. Similarly, in some embodiments the inventive system and methods will generate and utilize a more realistic representation of the user than may be used by other visualizations (which may instead use fashion models, outlines, generalized figures, etc.) that are typically used to assist a shopper to envision/understand how they would look in a particular item.

Note that in some embodiments, the inventive system and methods may be used to stimulate sales via enabling new marketing campaigns, social network based interactions and comments, generating more accurate product or service recommendations (for purchase or rental of garments and accessories), permitting the incorporation of “expert”/professional advice or suggestions into recommendations, facilitating the customized design and manufacture of clothing or accessories for a user, facilitating the process of altering a garment, etc.

For example, an embodiment of the inventive system and methods may provide data regarding an individual customer or aggregate data about a group of customers that may be used to:
Generate more reliable recommendations through application of collaborative filtering (e.g., based on designers or styles preferred by the customers' social network or people having a similar BMI (body mass index) and/or style preference);
Provide a mechanism for constructing “shared wardrobes”, wherein people of a similar BMI and style preference can collaborate on selecting or accessorizing an outfit or lend portions of a wardrobe to each other;
Provide a mechanism for a group of people to visualize how they would all look together, so as to prevent clashing styles or color combinations at events;
Assist in identifying a useful fashion “expert” or wardrobe recommender based on application of data mining techniques to discover those sales associates that demonstrate a higher than average likelihood of recommending wardrobe items that a customer finds desirable after being able to visualize themselves in the items;
Provide a way for a customer to “imagine” themselves in a particular venue, attending a specific event, in a specific setting, etc. wearing a particular set of items and/or accessories;
Serve advertisements or provide incentives to customers (such as for health clubs, exercises, hair colors, hair styles) based on their selection of styles, current BMI, desired BMI for certain styles, etc.;
Draw potential customers to a preview event by allowing them to first visualize themselves in a new line of clothing or accessories;
Unveil new fashions and accessories by suggesting items as part of the overall visualization; or
Permit the customization and manufacture of better fitting clothing by coupling data output by the inventive system and methods to a tailoring machine, 3D printing machine, automated weaving machine, or other form of automated or semi-automated manufacturing device.

Additional benefits that may be provided by an implementation of an embodiment of the inventive system and methods include:
Enabling independent designers to create garments and garment patterns using libraries of materials that have been stored. Connect this to customers who can purchase or license the designs from the designer and who can then submit them to a manufacturer for creation;
Enabling a third party to provide expert recommendations on garment choices for a customer;
Creating and implementing a secondary market for virtual clothing for games etc.;
Creating and implementing a secondary market for leasing out garment patterns to manufacturers; and
Creating and implementing a secondary market for fabric mills to sell their fabrics to designers.

As noted, additional problems that may be solved using an embodiment of the inventive system and methods include removing the broker from a transaction by giving a designer the power to design, assemble and test the apparel/furniture etc. in a virtual environment with a relatively high level of confidence that the simulation sufficiently mirrors reality to be of value to customers, retailers, and manufacturers. For example, a customer may be more willing to make a purchase because the customer has access to a realistic digital facsimile and they can visualize themselves wearing the garment or visualize a room with a given piece of furniture.

In some embodiments, the inventive system and methods may provide one or more of the following functions or capabilities:
Contextual fitting sessions—e.g., when a user chooses a garment on a retailers site, there may be a button/activatable element that initiates a session and a transmission of data such as garment UPC code, size, color, etc., to the inventive system in order to generate a representative digital facsimile of the user wearing the garment;
Integration with the retailer's site—an embodiment of the inventive system is generally not a standalone web service (although it may be for some types of business models or delivery mechanisms). Instead, it integrates with a retailer's site. Moreover, as the inventive system exposes web services, a retailer can customize the workflow as desired;
One-click fitting—if a user is already logged in, then the user doesn't have to enter any data. Information needed to generate the digital facsimile wearing the chosen garment is saved in connection with the users' garment. If the user is already logged in, the user will typically activate a button or other UI element, which will open a session with their digital facsimile wearing the selected garment;
Multiple Retailer Support—The inventive system integrates with any retailer as long as the system supports the garment, color, and size that are shown on the retailer's site;
Business Intelligence—As the inventive system supports a range of retailers and digital facsimiles, the system can offer insights into the range of body shapes and sizes, user choices, and emerging fashion/material/accessory trends;
Virtual Reality (VR) Environment and Viewing—the inventive system supports viewing the fitting session using a VR headset;
Photo-realistic Digital facsimiles and garments—the inventive system offers photo realistic digital facsimiles that closely mimic the users body size, skin tone, skin surface, hair, and facial structures. Garments demonstrate more accurate reflectivity and behavior using material/cloth physics models;
Accessories: Some embodiments of the inventive system include the ability to add hats, scarves, jewelry, shoes, gloves, make-up, hairstyle, hair color, etc. to the session. In some embodiments, one or more of the accessories may represent those offered by known brand names or stylists. For example, a user might “visit” several on-line eCommerce stores to select a variety of accessories from different companies. This enables the digital facsimile to display the user dressed in a desired pair of designer shoes, makeup, hairstyle, handbag, jewelry, etc;
Ability to save and add to the fitting sessions—A user can save the fitting session for later and add to it (such as by searching for and adding a particular coat and later the accessories); and
Ability to share a fitting session—A user can share a fitting session with friends—the friends can thus have the same user experience as the user/shopper (i.e., friends can see the user's digital facsimile wearing the dress, they can see a VR version of the session, etc. When sharing, a user may choose to make the session read-only or writeable (to enable comments/variations from the set of friends).

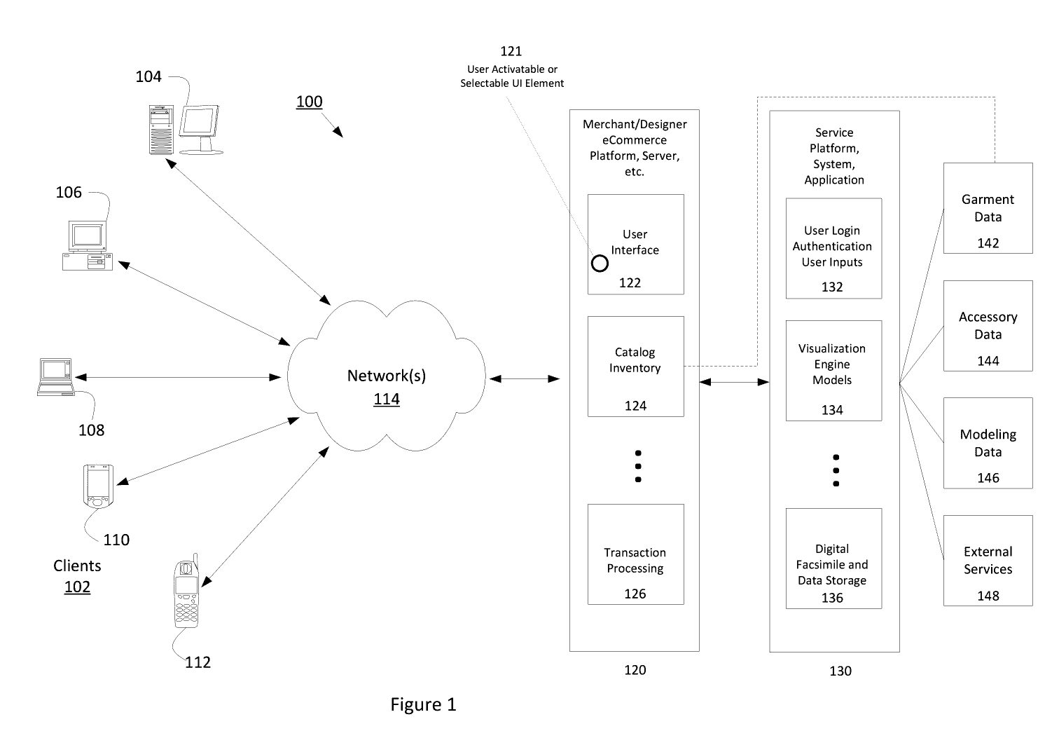

FIG. 1 is a diagram illustrating an operational environment or computing architecture 100 in which (or with which) an embodiment of the inventive system and methods may be implemented. As shown, a variety of clients 102 incorporating and/or incorporated into a variety of computing devices may communicate with a server 120 hosting a web-page or application through one or more networks 114. For example, a client may incorporate and/or be incorporated into a client application (e.g., software) implemented at least in part by one or more of the computing devices. Examples of suitable computing devices include personal computers, server computers 104, desktop computers 106, laptop computers 108, notebook computers, tablet computers or personal digital assistants (PDAs) 110, smart phones 112, cell phones, and consumer electronic devices incorporating one or more computing device components, such as one or more electronic processors, microprocessors, central processing units (CPU), or controllers. Examples of suitable networks 114 include networks utilizing wired and/or wireless communication technologies and networks operating in accordance with any suitable networking and/or communication protocol (e,g., the Internet).

A user may communicate with server 120 using a browser or other application. Such a browser or application will typically use a URL or other form of “address” to submit a request to server 120 for a particular web-page. Server 120 may be operated by or for a merchant, business, or other form of organization and may be part of a data processing system or platform (such as a business data processing platform that includes capabilities for processing inventory related data, sales data, business resource data, etc.).

In some embodiments of the inventive system and methods, server 120 may be associated with or part of an eCommerce platform or system that provides and manages an eCommerce web-site for a merchant or retailer. In such embodiments, server 120 (or the equivalent system or platform) may include one or more functional elements or modules, including (but not limited to, or required to include) a user interface 122 module, a catalog/inventory module 124, and a transaction processing module 126. User interface module 122 may include software instructions that, when executed by a suitable processing element, operate to generate and display one or more activate-able elements, display elements, form fields, data entry elements or regions, buttons, selectable elements, etc. In some embodiments, user interface 122 may include a selectable and/or activate-able button or other element 121, which permits a user to initiate or rejoin a “session” of the visualization and other services provided by the inventive system and methods.

Catalog or Inventory module 124 may include software instructions that, when executed by a suitable processing element, operate to manage and provide access to data representing the merchant's or designer's catalog of products. Such data may include text, images, video, and other forms of information (such as color, sizing, structure, fabric type, stylistic features, etc.). Catalog or Inventory module 124 may also include software instructions that, when executed by a suitable processing element, operate to manage certain inventory or inventory related functions or operations of the merchant's or designer's business, such as to update or revise inventory levels based on verified transactions, product in transit, product in storage, product on order, etc.

Transaction processing module 126 may include software instructions that, when executed by a suitable processing element, operate to manage the processing of a purchase transaction initiated by a customer. This may include providing functionality to enable a customer to provide payment for a purchase, to obtain authorization for the payment method, to arrange for customization, personalization, shipping, or other areas of fulfillment of the purchase, etc.

In some embodiments, when a customer/shopper activates or selects button or element 121, control may be transferred to the Service Platform, System, or Application 130 that is responsible for implementing certain of the functions, processes, methods, or operations associated with the inventive system and methods. Service Platform 130 may be implemented as a web-based or cloud-based service in accordance with one or more of several business models. Such business models may include (but are not limited to, or required to include) a subscription service, a single use service, etc.

Service Platform 130 may include a User Login and Authentication Module 132, which may be configured to accept one or more user inputs/credentials and in return authenticate a user and permit them to access the services and functionality of the platform 130. User Login and Authentication Module 132 may also permit a user to establish an account if they have not done so previously. The data entry functionality of User Login and Authentication Module 132 may enable a user to enter certain personal data (such as height, weight, age, etc.) that may be used to generate a digital facsimile representing the user.

Based at least in part on the information provided by the user (either contemporaneously, or during a previous session), Service Platform 130 may utilize one or more “models” of a person and/or a garment or accessory in order to generate a visualization of the user wearing one or more items. This may be accomplished by use of one or more “models” that are associated with Visualization Engine/Models module 134. Visualization Engine/Models module 134 may include software instructions that, when executed by a suitable processing element, are used to generate 2 or 3 dimensional representations of the user (with suitable customization or personalization, such as for hair color, hair style, body type, skin tone, makeup, age, etc.), of a specific garment (based on considerations of fabric type, garment style, stitching, fabric reflectivity, fabric movement or appearance under different environmental conditions (such as lighting, wind, shadowing, etc.)), or of a specific accessory (based on considerations of structure, material, reflectivity, etc.).

The models and associated methods or processes implemented by Visualization Engine/Models module 134 may be derived from considerations of physical properties, environmental conditions (altitude, wind, lighting, rain, etc.), scanning of a person or items, data mining of databases containing aggregate data for multiple persons of different age, weight, height, BMI, or other characteristics, etc. Data stores utilized in implementing embodiments of the inventive system and methods may be implemented with any suitable data storage technology, including structured query language (SQL) based relational database management systems (RDBMS).

Digital facsimile and Data Storage module 136 may be used to provide data storage of and access to the digital facsimile and related data for a user, as well as for data related to specific items of clothing or accessories (which in some cases may have been customized or personalized for that user). By associating the digital facsimile and other data with a specific user, that information may be shared with others at the user's direction (such as personal shoppers, designers, manufacturers, other retailers, etc.) and may also be used for other sessions in which the user wishes to visualize the same or a different item.

As suggested by Garment Data 142, Accessory Data 144, Modeling Data 146, and External Services 148, Service Platform 130 may be communicatively coupled to (or otherwise capable of message, instruction, and/or data exchange) with one or more services or data sources that are external to Service Platform 130. These may include data regarding Garments (such as characterizations or information regarding shape, patterns, fabric types, sizing, stylistic elements, etc., and may be provided by retailers and/or designers) or Accessories (such as characterizations or information regarding shape, materials, reflectivity, relative sizing, etc.). These external sources may also include Modeling Data 146 which may relate to improvements or extensions to mathematical/computational “models” used to generate certain aspects or characteristics of a person's Digital facsimile (such as to represent age related effects, changes in the relative distribution of weight or muscle, etc.) and/or of a Garment (such as to represent the effect of gravity, wind, motion, lighting, etc.). External Services 148 may represent sources of certain types of data processing, data mining, data analysis, machine learning, etc. that are utilized in generating a visualization, a recommendation, an estimated fit level for the garment, an estimated satisfaction level, or another aspect of the inventive system and methods.

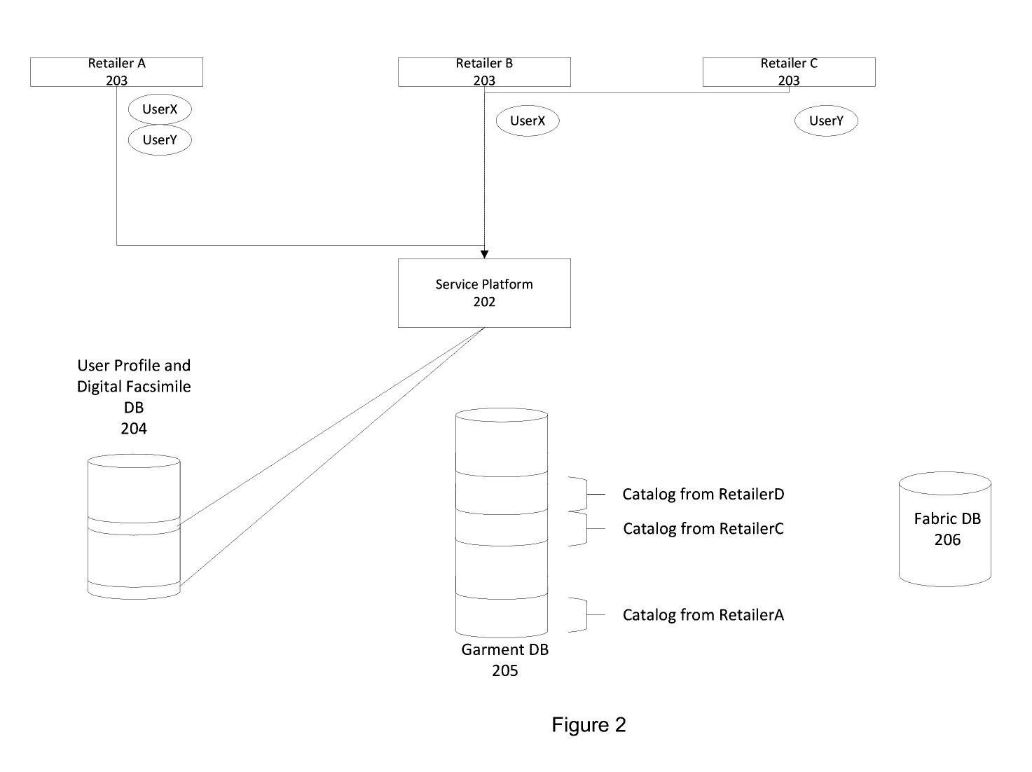

FIG. 2 is a diagram illustrating a possible system architecture that may be used to implement an embodiment of the inventive system and methods. As shown in the figure, a Service Platform 202 may be coupled to multiple Retailers 203 (with an associated set of Users), and may utilize one or more databases (elements 204, 205, and 206) that contain data and information regarding user's profiles and Digital facsimiles (204), Garments (205), and Fabrics (206). The databases may contain information and data used to determine the parameters used in computational models for the purpose of characterizing and visualizing people, garments, and fabrics. The computational models may incorporate data regarding, and representations of, the fabrics or materials used in a garment and the behavior and appearance of the garment under different environmental or movement conditions.

In some embodiments of the inventive system, data regarding the fabric, materials, or the constructed garment may be obtained as a result of measurements made by use of an inventive fabric scanner, aspects of which are described herein. The data regarding the fabric, materials, or the constructed garment may be used to populate a data structure that characterizes one or more aspects or characteristics of the fabric, materials, or garment, where such a data structure may include (but is not required to, and is not limited to including):
a stress tensor for the fabric;
a vector representing a force applied to the garment by the body or appendages of a person wearing the garment;
a vector representing a force applied to the garment by an environmental condition, such as wind or rain;
a tensor representing the reflectivity of the garment in general, or at a specified wavelength; and
a data structure representing the general physical appearance of a person having the physical characteristics of the user (such as height, weight, BMI, age, general build, etc.).

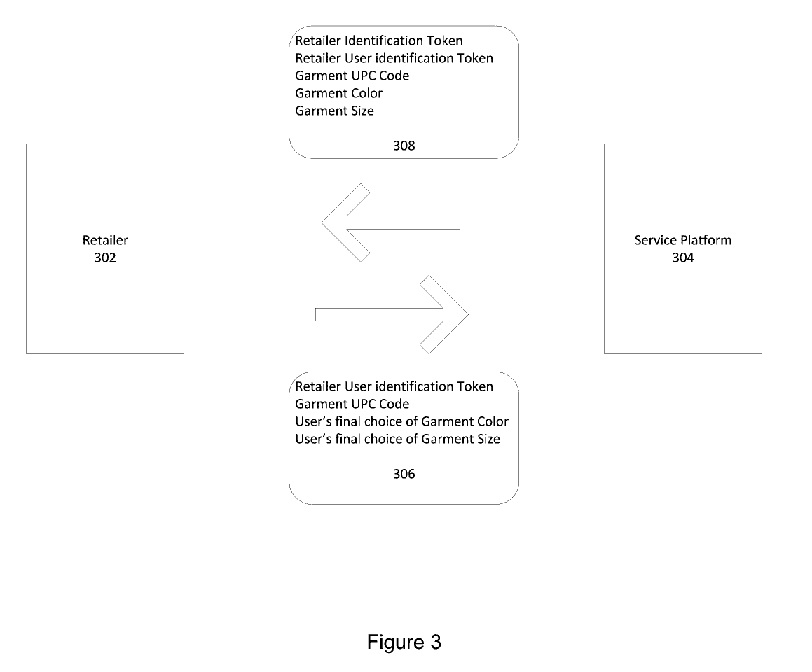

FIG. 3 is a diagram illustrating an example of certain data that may be exchanged between a retailer/merchant (302) and the service platform (304) as part of implementing an embodiment of the inventive system and methods. As shown in the figure, a retailer/merchant's eCommerce platform 302 or similar data processing platform (such as Platform 120 of FIG. 1) may provide data 306 (e.g., a user's identification token or tokens, a general garment identification number, string, or code, and/or garment characteristics such as size, color, style, etc.) to Service Platform 304 (such as Platform 130 of FIG. 1) for use in providing the user with a visualization of themselves wearing the garment. Similarly, in response to a user's selection or confirmation, Service Platform 304 may provide the user's choice of garment, garment color, garment size and other relevant characteristics 308 to Retailer 302 for purposes of initiating a purchase transaction. Note that as suggested by the dotted line in FIG. 1, information regarding a retailer's products/garments may be provided to Service Platform 130 directly, and/or indirectly via Garment Data store 142 (which may have received and stored data regarding the retailer's products previously in a database, such as an indexed data structure which can return a set of data used to generate a visualization of the garment in response to a UPC code or other identifier).

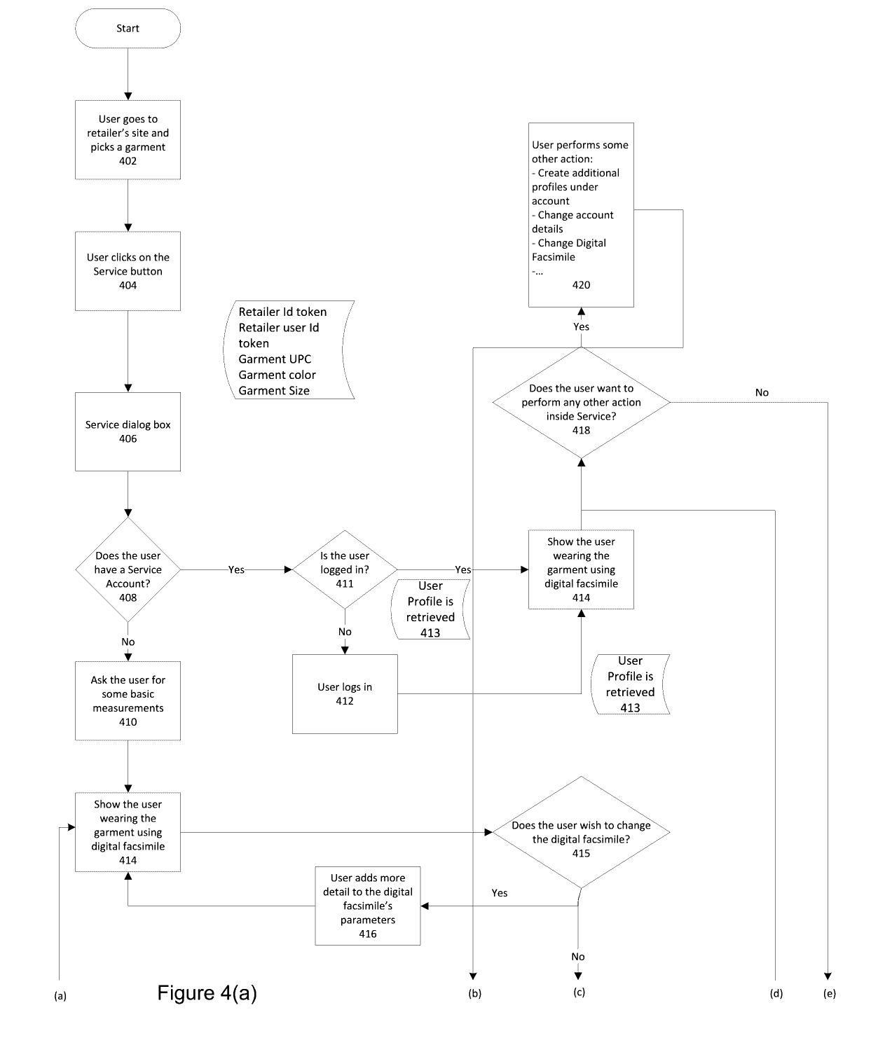

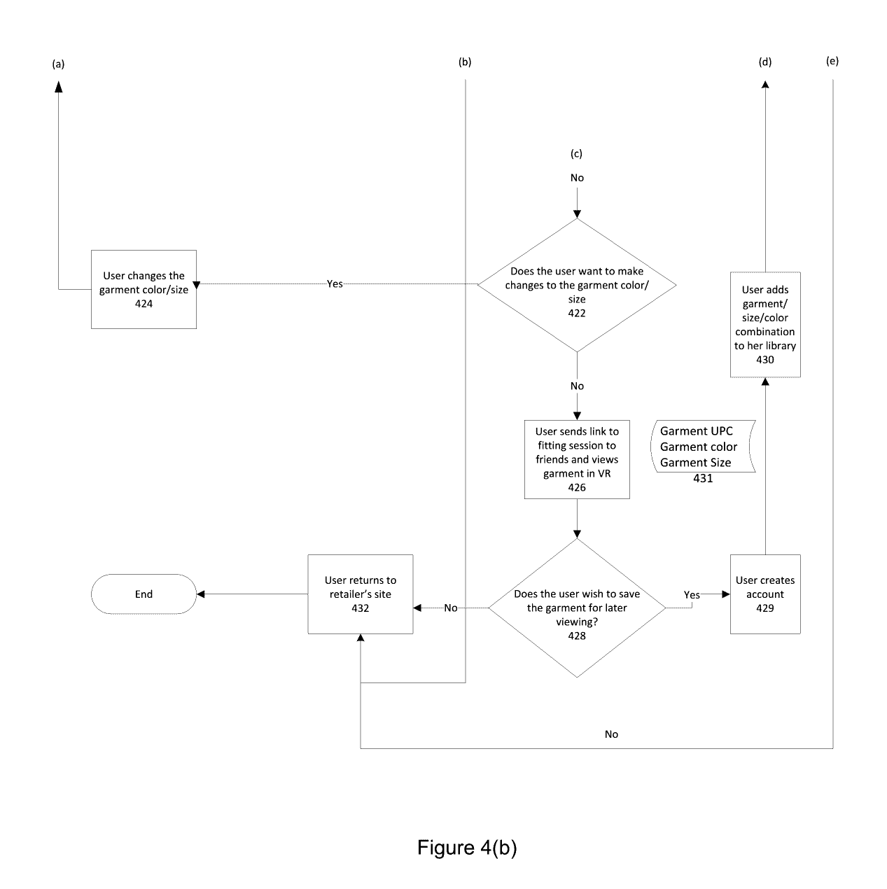

FIGS. 4(a) and 4(b) are flowcharts or flow diagrams illustrating a process, method, or operation for function that may be used when implementing an embodiment of the invention. As shown in the figure, a user may interact with the inventive service platform in order to select a garment or accessory to be viewed, view a generated visualization of themselves wearing the garment or accessory, adjust certain parameters of the garment or accessory, and if desired, select the garment or accessory for purchase or for the storage of its parameters and/or visualization.

As shown in FIGS. 4(a) and 4(b), in an example use case, a user/customer may interact with the system or platform in accordance with the following process steps and data flow. A session, system session or fitting session is the data and workflow stored when a user selects and views themselves in a given garment, accessory, hairstyle, hair color, skin tone, weight distribution, etc. A session has a unique identifier and may be shared with others. FIGS. 4(a) and 4(b) correspond to a possible data flow for Scenario 1, discussed below.

As shown in FIGS. 4(a) and 4(b), an example process/data flow for user selection of a garment for presentation as a digital facsimile, user specification of certain digital facsimile parameters and/or environmental variables, etc. that may be implemented in an embodiment of the inventive system and methods:
1. User selects a garment from a retail site—the garment characteristics and parameters are part of a data structure that can be accessed or made available to the inventive system (as suggested by step or stage 402);
2. User clicks on a button on the retail site to select/activate the inventive service (as suggested by step or stage 404, where as shown certain information or data regarding the selected garment and the retailer may be passed to the service platform);
3. User opens up a dialog/data entry field (as suggested by step or stage 406);
4. System determines if the user/customer has an existing service account or profile (as suggested by step or stage 408);
5. If the user does not have a current service account, then the user may be asked to enter basic information—for example, one or more of height, weight, sex, age (as suggested by step or stage 410);
6. However, if the user does have a current service account, then the system may determine if the user is logged into their account (as suggested by step or stage 411), and if not, the user may be requested to log into their service account (as suggested by step or stage 412);
7. If the user has a service account and is logged into that account, then the system will retrieve or access the user's previously established profile (as suggested by data elements 413);
8. The system generates digital facsimile and presents to user—user sees a 3D representation of themselves with their measurements wearing the virtual version of the selected garment (which is generated in such a way as to obey the cloth behavior/physics of the original garment) (as suggested by step or stage 414)—note that in the use case in which the user has not previously selected or constructed an digital facsimile (corresponding to step or stage 410), the user may be provided with an opportunity to adjust or vary the parameters used to generate the digital facsimile (as suggested by step or stage 415), and if they desire to do so, may add additional details or characteristics to the digital facsimile, or adjust certain of the parameters of the digital facsimile, and hence change their user profile (as suggested by step or stage 416);
9. A user may also be asked if they wish to perform any other actions or access other aspects of the service, or if they wish to modify an aspect of their account (as suggested by step or stage 418)—if they do, they may be presented with a list or set of possible options, such as (but not meant to be required or confined to) creating a new profile, changing an aspect of their digital facsimile, or changing account information (as suggested by element 420);
10. Next, as shown in FIG. 4(b), the user may be offered one or more options with regards to the appearance of the garment, such as changing its size, color, features, etc. (as suggested by stage or step 422)—the user can choose to customize/personalize the digital facsimile by entering more data or measurements using a tiered approach—the more data, the more accurate or realistic the digital facsimile (where the additional data may include information such as pant waist size, inseam, chest measurement, neck size, hat size, etc.) (as suggested by step or stage 424);
11. If the user has changed one or more parameters or characteristics of the garment, the revised description of the garment is stored and a revised visualization is presented to the user;
12. Once the user has decided that the combined digital facsimile and garment visualization is acceptable, the user may send a link to the session to others they wish to view it and/or the user may view the garment and/or the digital facsimile wearing the garment in a virtual reality environment (as suggested by step or stage 426);
13. The user may be asked whether they wish to save the garment definition for subsequent viewing (as suggested by step or stage 428)—if they do wish to save the garment definition, then they may be provided with an opportunity to create an account and/or add the garment definition data to the “library” of garments associated with their account (as suggested by steps or stages 429 and 430, and data elements 431);
14. Control of the process flow may then be returned to the retailer's site (as suggested by step or stage 432);
15. Note that in addition to selecting the parameters or characteristics of the digital facsimile and/or the garment, a user may also adjust, select, specify or vary one or more of the following parameters or characteristics:
   a. environmental variables (these may include, but are not limited to lighting, rain, clouds, or background)
   b. accessories (e.g., makeup style or type, hairstyle, hair tint, handbag, watch, earrings, necklace, hat, shoes, etc.)—in some cases accessories may be selected from well-known designers or merchants, generated recommendations (based on collaborative filtering or style categories), or personal shopper suggestions; or
   c. a user can customize the digital facsimile/facsimile with their face by providing image, headshots, etc.

As noted, a user can save the session and create an account for later viewing or sharing. The user's measurements and characteristic data are stored by the system for later usage. In order to solicit feedback or assist in planning for an event, a user can disseminate a link to the session to friends/consultants/shoppers who can then view the user wearing the garment with the selected accessories. As noted, the user can view the garment in a virtual reality mode (VR) using an appropriate device (such as a head-mounted visor).

If the user selects another garment, no new data is needed—the user goes directly to a view of themselves wearing the garment, as the user has logged into the service already and a session identifier is stored on the user's local machine. If the user goes to another (different) retail site that uses the same service, then the user's preferences/measurements are available, having been stored by the system.

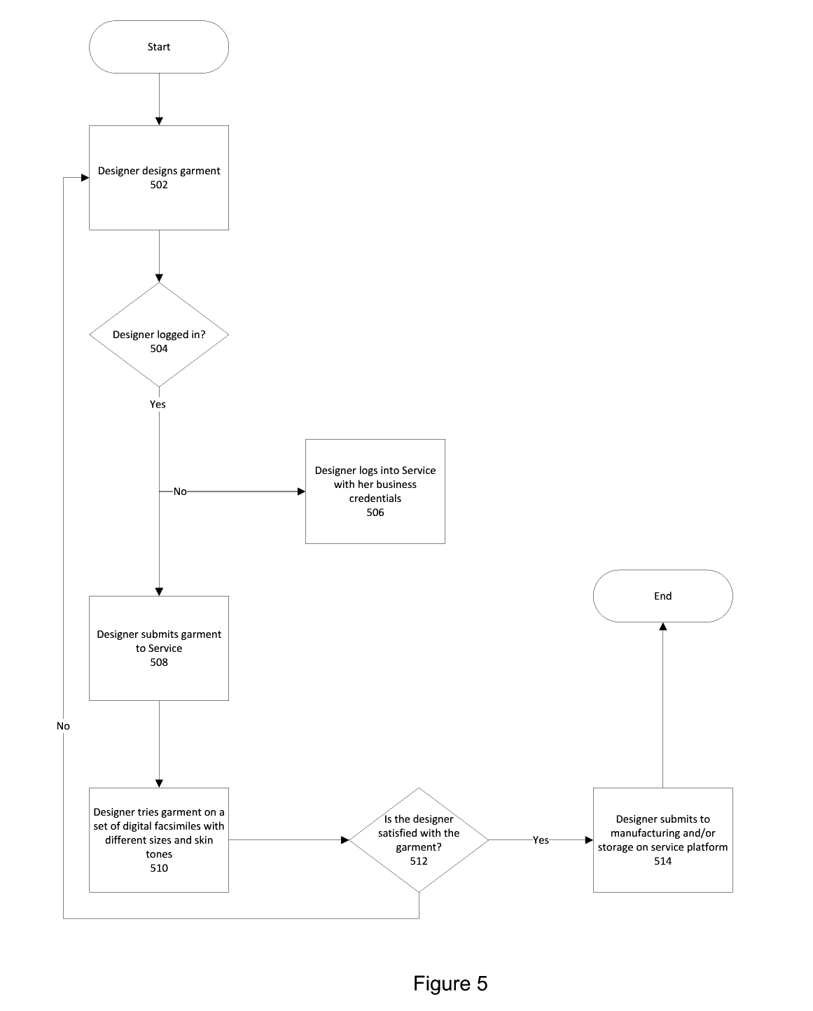

FIG. 5 is a flowchart or flow diagram illustrating a process, method, or operation for function that may be used when implementing an embodiment of the invention. FIG. 5 corresponds to a possible data flow for Scenario 2, discussed below. As shown in the figure, a designer may interact with the inventive service platform in order to determine if a particular design has the appearance they desire when viewed as being worn by one or more digital facsimiles provided by the service platform. Note that in some embodiments, a designer may be provided with the option to view the digital facsimile wearing the garment under different environmental conditions (such as different lighting, different backgrounds, wind, rain, etc.).

Further, in some embodiments, a designer may be provided with an option to create a file or set of instructions for execution by a processor controlling a 3D printer, automated weaving machine, or other automated garment or accessory manufacturing device or system in order to be able to manufacture the garment or accessory in accordance with the designer's specifications. Note that the “models” developed and utilized by the inventive system and methods may be used for purposes of visualizing a garment on a digital facsimile and also (or instead) for scaling the dimensions or sizing of a design for purposes of making it fit as desired on different sizes or proportioned customers.

In this example use case (as shown in FIG. 5), the illustrated process flow permits a garment designer to utilize aspects of the inventive system as part of manufacturing a garment:
1. Designer makes a sketch of the garment (as suggested by step or stage 502);
2. The system determines if the designer is logged into an account (as suggested by step or stage 504);
3. If the designer is not logged into a service account, then they may be asked to log in or to create an account (as suggested by step or stage 506);
4. The designer may submit the designed garment to the service in a suitable format (such as CAD elements and data formats) or may be able to assemble the garment in CAD or other visualization environment that is hosted by the service platform (as suggested by step or stage 508);
5. The service platform generates a visualization of the garment as being worn by or displayed on a 3D digital facsimile using the cloth behavior/physics models used by the inventive system (as suggested by step or stage 510)—note that the designer may be provided with a tool or user interface that may be used to vary certain characteristics of the digital facsimile, including but not required or limited to size, body proportions, skin tone, eye color, hair color, hair style, general build, etc. (as suggested by the logic passing control from 512 back to 502);

As part of the evaluation of their satisfaction with the garment and its appearance and movement on the digital facsimile or digital facsimiles, the user may be able to perform one or more of the following operations or functions:
the 3D digital facsimile/garment model can be moved around to provide views of the design garment from different perspectives;
if desired, the designer can use a VR platform to view the digital facsimile wearing the garment;
   the designer can go back to the CAD environment, modify the design and then review the garment/digital facsimile until the garment appears, fits and moves with the wearer as desired; and
6. When the designer is satisfied, the dress is stored in the inventive system and may be made available to users, manufacturers, etc. (as suggested by step or stage 514),

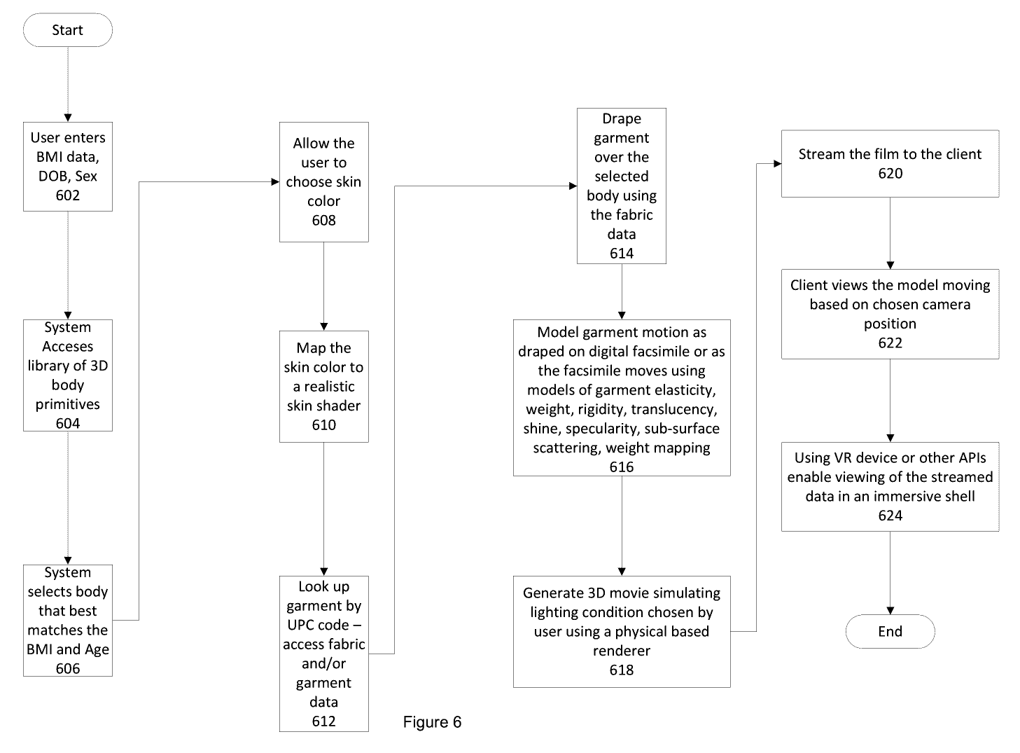

FIG. 6 is a flowchart or flow diagram illustrating a process, method, operation or function that a user may interact with to generate a suitable digital facsimile, generate a model of how a selected garment would appear on that digital facsimile, and enable the user to visualize the selected garment on the digital facsimile in varying lighting or other environmental conditions, and that may be used when implementing an embodiment of the invention. As shown in the figure, a user may be requested to enter certain information about themselves, such as date of birth and body mass index (as suggested by step or stage 602), or in some cases more specific information (such as height, weight, eye color, sex, hair color, etc.), and in response, the inventive service platform may determine the most appropriate digital facsimile to be used to represent that user (as suggested by steps or stages 604 and 606).

This baseline digital facsimile may be selected from a set of digital facsimiles that represent “standard” or common body types or relative human proportions, based on scans of actual persons, data mining of a large set of data representing measurements of people's height, weight, waist, etc. (alone, or as a function of age, fitness, or other characteristic). The user may also be provided with an ability to enter or select additional and generally more specific information about their appearance in order to cause the digital facsimile to more closely resemble them (such as age, skin tone, hair color, hair style, etc., as suggested by step or stage 608). In the case of skin, eye, or hair color, the entered or selected shade may be mapped to a shader application or function (as suggested by step or stage 610). As also illustrated in the figure, a garment's UPC code or other identifier may be used to access data that can be used to generate a model of the garment and its appearance and motion characteristics when worn by the user (as suggested by step or stage 612).

Note that, as will be described in greater detail, the garment may be associated with a service platform data record that provides information regarding the garment fabric and its behavior under different loading and environmental conditions, and a set of models or representations of how the fabric and features of the garment construction (seams, buttons, folds, pleats, etc.) will behave and/or appear when subjected to different lighting, wind, loading, or movement. These models or representations may include, but are not limited to or required to include elasticity, reflectivity, etc. In some embodiments, information about a fabric that can be used to generate the models or representations may be obtained by using an inventive fabric scanner, which will be described in greater detail.

After using an identifier for the garment (such as the UPC code), the service platform may access data regarding the garment and/or fabric from which the garment is constructed (as suggested by step or stage 612). As noted, some or all of this data may be obtained by using the inventive fabric scanner to characterize the fabric. The selected garment is then draped over the user's “body” model (as suggested by step or stage 614). Note that the garment motion and/or appearance when draped on the representation of the user's body may be determined by use of one or more “models” of how the garment behaves when subject to different conditions (as suggested by step or stage 616). These models may be based on physical principles and include models of a garment's elasticity, reflectivity, rigidity, localized folds or overlaps, etc. The garment may be modeled as draped over the digital facsimile and/or as it would appear where the digital facsimile is in motion or in differing environmental conditions.

Next, the service platform may generate a 3D movie or other form of visualization of the digital facsimile wearing the garment under one or more environmental conditions or settings (as suggested by step or stage 618). This may be done using a suitable rendering pipeline that is resident on the platform or accessible by the platform. The movie or other form of visualization may then be streamed to the user for their consumption (as suggested by step or stage 620). The user may view the streamed data using any suitable viewing device or process (as suggested by step or stage 622 and 624). Note that the movie or other form of visualization may be modified to show the digital facsimile wearing the garment (at rest or in motion) from a specified camera angle or perspective, or if desired, in a VR or augmented VR environment.

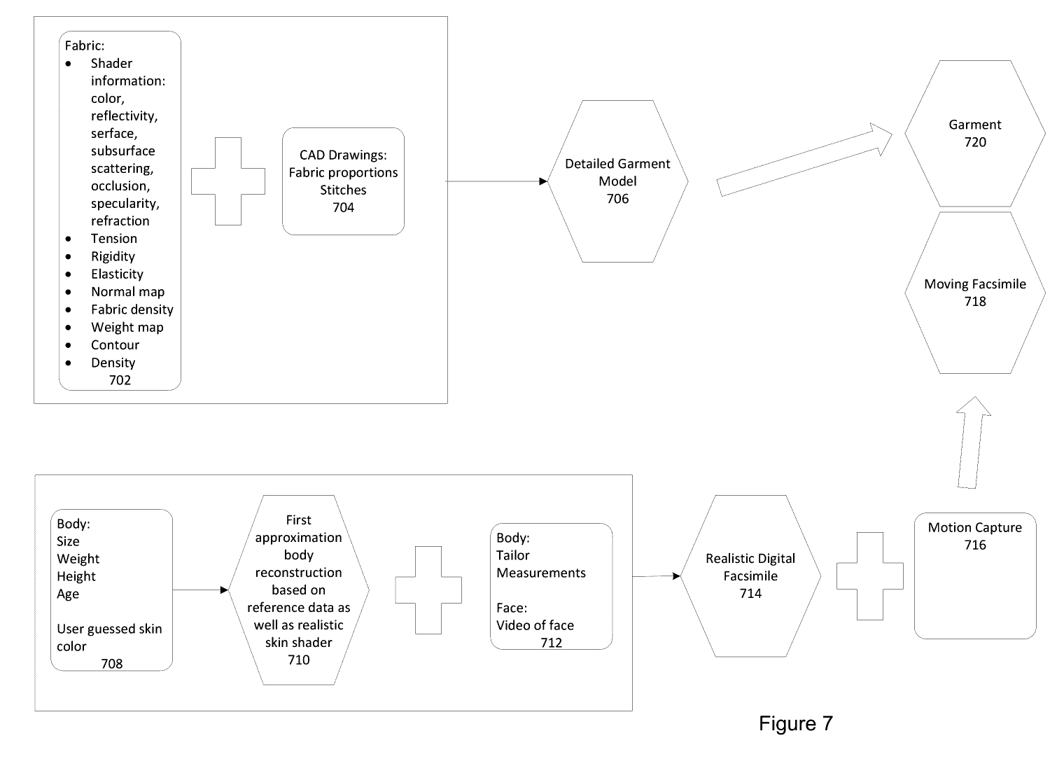

FIG. 7 is a flowchart or flow diagram illustrating a possible data flow that may be used when implementing an embodiment of the invention. As shown in the figure, certain types of data may be accessed or requested from a user, and in response the inventive service platform may operate to generate a digital facsimile representing the user and a representation of a selected garment. As shown in the figure, when modeling a garment, an analysis may be made of the garment, with certain characteristics of the garment being determined and stored. These characteristics may (but are not required to) include:
Shader information for the fabric such as
   color, reflectivity, surface, subsurface scattering, occlusion, specularity, refraction, etc.; and
Fabric physical behavior characteristics and models, including, for example
   Tension, Rigidity, Elasticity, Normal map, Fabric density, Weight map, Contour, and Density.

The fabric related data (as suggested by element 702) may then be combined with data derived from a CAD system or other visualization system for a garment constructed from the fabric (as suggested by element 704). This combination of data and models may then be used to generate a model of the constructed garment itself (as suggested by element 706).

Similarly, an digital facsimile or representation of the user/customer may be constructed from limited data provided by the user/customer in combination with body models or representations that are derived from analysis of aggregate data that supports the use of a relatively small set of parameters (such as height, weight, age, general body type) to approximately characterize a person's general physical appearance. An digital facsimile based on this limited data may be personalized by a user's selection of a skin color or shade, eye color, and hair color, for example. The digital facsimile may also be further personalized to the user by adjustments to the digital facsimile's physical characteristics (such as build, bust, shirt size, dress size, etc.) and if desired, the addition of an image or video of the user's face. As shown in the figure, a relatively small set of data may be provided by the user (as suggested by element 708) and used to generate an initial digital facsimile or physical representation of the user's physical appearance (as suggested by element 710). This initial representation may be derived from analysis of how a person's approximate physical appearance may be determined from a relatively small set of parameters (such as age, BMI, general build, etc.). The initial digital facsimile may then be “fine-tuned” to more accurately represent the user by selection of one or more specific physical attributes, such as eye color, hair color, facial image, etc. (as suggested by element 712), to produce a relatively realistic digital facsimile (element 714).

In some embodiments, a suitable motion capture technology (such as an arrangement of cameras, tracking devices, and sensors) may be used to enable visualization of a moving digital facsimile (as suggested by elements 716 and 718) wearing a realistic image of the garment (element 720) that behaves in accordance with physical principles when subjected to changes in lighting, wind, or other environmental conditions.

### Fabric or Material Characterization

As mentioned, in some embodiments, a “model” of a garment may include information to enable estimation of how the fabric and its attachments (seams, buttons, pocket flaps, etc.) will rest on a person, respond to environmental changes (lighting, wind, rain, etc.), and/or move as a person wearing the garment moves. In some embodiments, information about a garment and the material(s) from which it is constructed may be used to determine one or more parameters of a “fabric model”. In order to obtain at least some of this information, the inventors developed a “fabric scanner” as described below and in U.S. Provisional Application No. 62/243,513, entitled “System and Methods for Characterizing a Fabric or Material,” filed Oct. 19, 2015, which is incorporated by reference in its entirety herein (including the Appendix) for all purposes.

The scanner and its associated data collection and analysis methods may be used to measure and evaluate certain characteristics of a fabric or other material, with those characteristics being used directly or indirectly (such as after being subjected to further data processing, signal processing, machine learning, statistical analysis, eta) to populate one or more parameters of a mathematical model for the fabric or for a garment constructed from the fabric. Note that the data obtained from operation of the scanner may be used to construct or refine a mathematical model (such as by using data mining, curve fitting, or machine learning techniques) and/or to provide one or more parameters or values that are used for purposes of populating an existing model.

The scanner/material characterization system may be used to determine certain physical properties of a material, fabric, substrate, etc., where those properties may be expressed in terms of one or more relevant parameters, such as density, tensile strength, susceptibility to deformation, reflectivity, etc. Such parameters/properties may be used as inputs to a model or characterization of a garment to provide a more accurate and realistic “prediction” or representation of how a garment will look and react under different environmental conditions (such as lighting, cloud cover, wind, moisture, movement by the person wearing the garment, eta). This provides a source of data for a visualization engine or other element that generates an image or representation of the garment, of a person wearing the garment, or of a person wearing the garment under specified environmental conditions (such as at the beach, in cloudy weather, in wind, etc.).

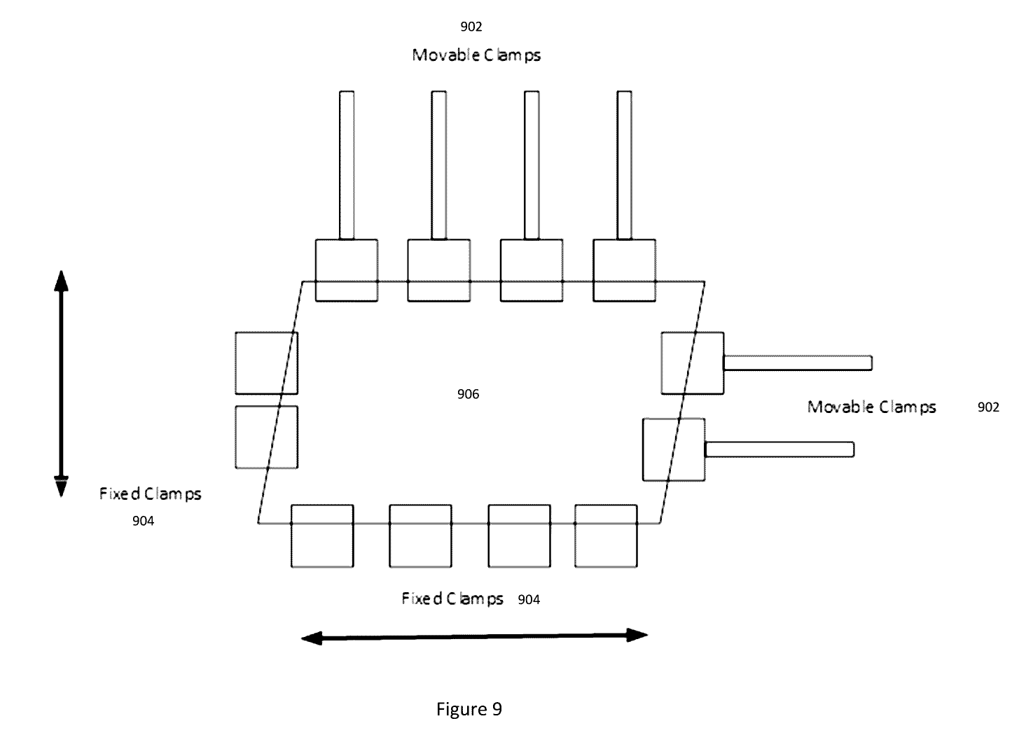

FIGS. 9-11 figures illustrate and explain certain aspects, elements, functions, operations, and processes of an embodiment of an inventive material or fabric measurement and characterization system. These diagrams illustrate components of and methods of using a fabric or material scanner or characterization system that may be used when implementing an embodiment of the inventive visualization platform or system.

FIG. 9 is a diagram illustrating a mechanism that may be used to clamp and apply forces to a piece of material or fabric as part of an implementation of an embodiment of the material or fabric characterization system. As shown in the figure, one or more movable clamps (elements 902) may be used in conjunction with one or more fixed clamps (element 904) to properly position and hold a piece of fabric or other material (element 906) that is being analyzed.

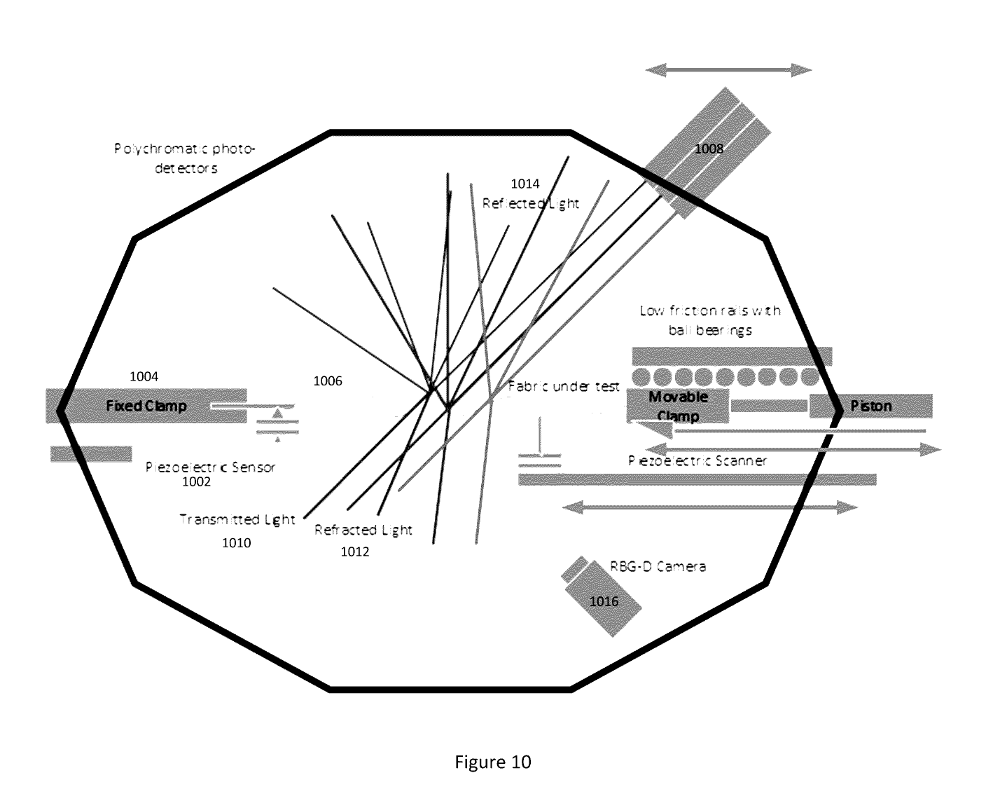

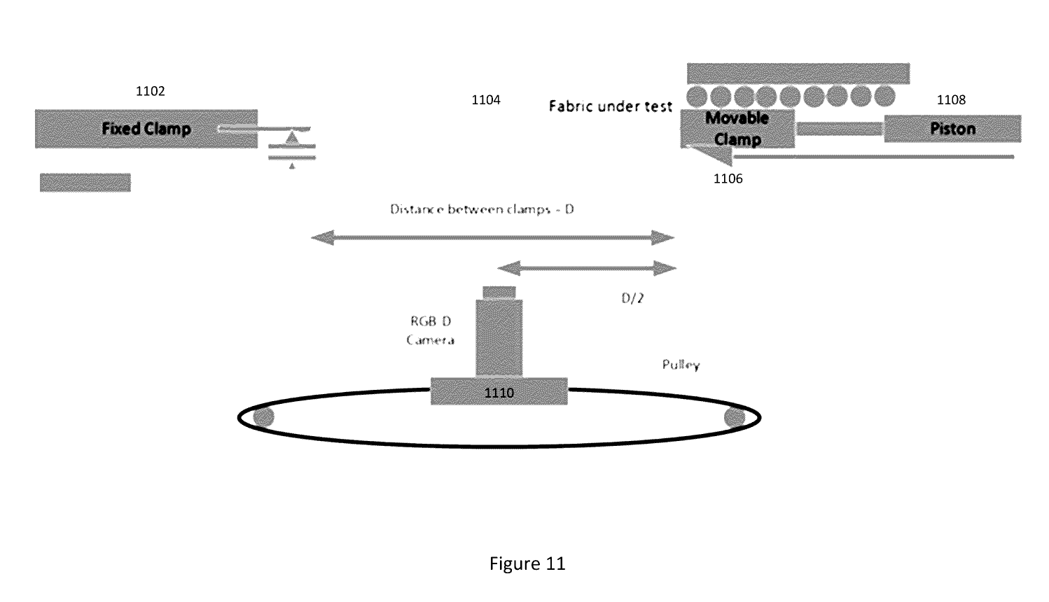

FIGS. 10 and 11 are diagrams illustrating a mechanism or mechanisms that may be used to collect data regarding the force on a material when stretched a known (calibrated) distance or increment as part of an implementation of an embodiment of the scanner or material characterization system and methods.

Note that in addition to shear, when characterizing a material/fabric, it may also be useful to measure the twist of the material/fabric in response to an applied torque; this information may be useful in modeling how apparel responds to being “bunched” or compressed. The twist or response to torque of a material/fabric may be obtained by marking grid points on the material/fabric, and measuring the strain on the material as it is twisted. In addition, the scanner may be used to measure the torque needed to produce a given twist (e.g., as expressed in terms of angular displacement, as in a torsion balance). When the material under application of a “twist” goes slack, the scanner can measure a wrinkle or wrinkles in the material (for example, linen). Similarly, the inventive scanner and associated elements or processes can be used to analyze folds or the interaction of different materials with each other,

In this scenario, relaxing the clamps triggers the movable RGB-D camera, which is located half the distance between the clamps, to take a depth photograph of the material sagging. Using a suitable edge detection technique (e.g., Canny or Rothwell), the scanner may calculate the curvature of the sag to determine the material's “warp factor”. The scanner may also be able to determine the rigidity of the material.

The scanner may use a high frequency sound wave to measure the metallicity vs. dielectric properties of the material. For example, if the material has a relatively high reflectivity of sound waves, then it is a smooth, thick material (such as polished leather); if the material transmits sound, then it is a thin, smooth material (such as silk); if the material absorbs sound, then it is likely to be fluffy and therefore more a dielectric material. Sound reflectivity, transmission, and absorption can be correlated with measurements made by the optical system(s) of the scanner.

In one implementation (as suggested by FIG. 10), a piezoelectric sensor 1002 is mounted on several of the fixed clamps 1004 to enable measurement of waves that have propagated across the fabric under test 1006; a wave generator may be located on the movable clamp. The wave generator produces a reference wave (of known amplitude and frequency) that can be changed as needed (for example, to characterize the material with regards to a cut-off point for wave propagation). The piezoelectric sensor(s) measure wave propagation velocity and the attenuation of the input wave/signal; the data may be recorded in terms of a relative signal strength reflected or scattered by a feature of the surface. A source of light (e.g., laser, LEDs, etc.) 1008 is used to illuminate the fabric under test 1006 that is held in place by the clamps 1004. The interaction of the light with the fabric will produce components of one or more of transmitted light 1010, refracted light 1012, and reflected light 1014. An imaging device such as a RGB camera 1016 may be used to capture a multi-spectral image or images of the illuminated fabric.

FIG. 11 is a diagram illustrating a section of fabric or material placed under a stretching, pulling or twisting force in order to enable measurements of the response of the fabric or material to that force. As shown in the figure, a fixed clamp 1102 may be used to secure one end or the ends of the fabric under test 1104. A movable clamp 1106 may be used to secure the other end or ends of the fabric. Movable clamp 1106 may be driven by a piston 1108 or other suitable mechanism. An imaging device or camera 1110 (such as a RGB-D camera) may be used to obtain precision images of the response of the fabric under test to the applied force or forces. These may be used to obtain measurements of the fabric's motion in response to the forces and ultimately to assist in populating the data structures mentioned previously with reference to FIG. 2.

In some embodiments, the elements, functions, and capabilities of the scanner or material characterization system may include the following functional elements or modules:
Material Friction Scanner (MFS)—this may be implemented by running a Teflon coated wedge shaped piezo-electric brush over the surface of the material. The intensity and frequency of the resulting signal is an indication of the “roughness” of the material and thus the friction. A second test is to run a calibrated block of a given material and then measure the resistance as the block is moved over the surface. By knowing the resistance and the calibrated coefficient of friction, comparisons can be made against a baseline material;
Material Stress & Strain System (MS3)—by pulling and tugging the material, it is possible to gauge the “elasticity” of the fabric—the force pulling against the fabric and resistance of the fabric against that force. The inventive scanner may perform this evaluation in the X, Y, and Z directions, resulting in data to populate a second order tensor field. The scanner can also calculate the ability of the material to “twist” and untwist by applying a given torque to the material and measuring the resistance to movement;
Material Density System (MDS)—the scanner can send a frequency pulse through a material that is stretched so that the state of stress matches a standard. A wave then propagates through the material. The dampening of the wave, as reflected by changes in wavelength, amplitude, or velocity can be measured using a piezoelectric sensor at another location on the material, and then compared against one or more sets of baseline data for materials. Silk, for example, does not significantly dampen the signal, while wool will dampen the signal. This measurement can be used to indicate how the material will “flutter” under different environmental conditions, or the “twirl” factor;
Material Thermal System (MTS)—although this is not used to calculate visible material properties, it could be useful in determining how well a material retains heat. This can be done by using a standard “candle” (such as a heat lamp) at a known power emission and then measuring the heat absorption on the other side of the material;

Using an RGB-D camera and an arrangement of lights and detectors, the system characterizes the optical properties of the material. These properties may include one or more of:
Color: this may be determined by shining lights on a material at different frequencies, measuring the reflected, transmitted, and scattered light from the material at different frequencies (and at different angles of incidence). The resulting data is used to construct a shader model for the material (allowing elements of its appearance under different lighting conditions to be modeled);
Transparency/Translucency: using the light arrangement described, the scanner can measure the amount of light transmitted through a material (as a function of frequency/color). This system can also measure the light refracted by the material. This data may also (or instead) be used in a particular shader model;
Albedo: the scanner can measure the absorption of light by the material, or its “velvet” properties. This is related to the amount of energy that is absorbed by the material at different frequencies, and may provide a component of a shader model; and
Texture: the camera can be used to provide an accurate image of the material texture, allowing calculation of normal maps and bump maps.

### Example of the Operation of the Scanning Device

An example of a process or workflow for operating the scanning device is as follows (assuming that each component of the device has been calibrated, recalibrated, or it has been found that subsequent calibration is no longer necessary):
A swatch of cloth is attached by the user to fixed clamps on two edges that share a common corner; the opposite end of the fabric is connected to a moveable clamp;
The optical elements of the system illuminate and scan the material to measure optical and textural properties (e.g., color, opacity, reflection, granularity, etc., some or all of which may be used to characterize a material and distinguish it from other materials);
The appropriate system elements make measurements for purposes of determining the stress-strain tensor of the material;
The appropriate system elements may then be used to measure properties related to the sag of the material;
The appropriate system elements may then be used to measure properties related to the resistance of the material to sliding or moving against another material or object; and
If desired, certain thermal properties of a material may be determined based on measurements of heat transfer across or through a material, material density, etc.
   Note that seams and other boundaries can also be modeled or simulated by recording the impact of the seam on wave propagation, and stress and strain characteristics. As mentioned, a model of a garment may be created in a CAD system. Material zones and seams are then inserted into the CAD drawing. The material zones are parameterized based on the fabric being used for that portion of the garment. By knowing the relevant parameters at multiple points on the garment, users of the scanner can simulate the overall garment draped on a specific individual. Knowing the point stress and strain tensor along edges can be used to calculate downward forces against the person's flesh underneath the garment. This may factor into its comfort (e.g., its “itchiness”) or use in certain situations.

In one embodiment, the scanner or material analyzer operates to scan a piece of fabric or other material using a device similar to the one shown in FIGS. 10 and 11 (note the figure is a cross section, shown along the XZ axis). A similar set of elements is positioned along the YZ axis. RGB light bundles (not shown, but may be implemented in the form of LED emitters or another suitable source of illumination) are located in positions spaced along both the X axis and the Y axis. The light bundles are arranged, configured, and operable to illuminate the material, resulting in one or more of reflected, scattered, transmitted or refracted light after interacting with the material/fabric. The reflected, scattered, transmitted or refracted light may be detected by polychromatic sensors; the sensor outputs may be provided to one or more of a converter or data processing device which executes one or more signal processing applications. The signal processing applications are used to provide information related to the structure of the fabric and/or to its response to specific environmental conditions (lighting, wind, rain, stress, loading, etc.), or to changes in environmental conditions. This information may then be used as an input to a simulation or model of an item of apparel that is made from the fabric (where it is noted that simulating or modeling the item of apparel may involve additional data processing and/or modeling operations, such as to account for the impact of buttons, flaps, seams, etc.). Note that although the use of light bundles has been described, other sources of illuminating light (such as lasers) or even emitters operating at non-visual wavelengths (such as radar or acoustic emitters) may be used to gather relevant data regarding the response of a material.

In some embodiments, a piezoelectric sensor may be used to detect the characteristics of one or more of frequency, wavelength (based on the spacing of signals), or amplitude (based on the strength of a signal) of a physical wave propagating through the material; this information may be used to calculate the stress-strain tensor of the material. Another possible data collection scenario involves use of one or more of the clamps shown in the figures; in this situation, the clamp(s) are used to stretch the material to different (calibrated) distances along one or both of the X and Y-axis. This information may be used to determine the stress-strain tensor of the material. The thickness of the fabric can be measured by sensors in the clamps themselves that calculate how far apart the clamps are when tightened. Thickness may be an important parameter to measure because it can be used in simulations and impacts how a material behaves.

The scanner may be used to acquire data and information regarding the physical properties and behavior of a material, fabric, substrate, surface, etc. This data and information may then be used to set one or more parameters of a model or process that is used to determine the appearance of an article constructed from the material, fabric, substrate, surface, etc., and also (if desired) how the article responds to different environmental conditions (such as lighting, moisture, wind, background, etc.). As described herein, one example of such a use case is that of a system that generates realistic images of clothing or other items manufactured from a material or fabric.

### Example Fields of Use of an Embodiment of the Inventive System

An embodiment of the inventive system and methods may be used for multiple design, manufacture, or simulation tasks. These include, but are not limited to, the following:
3D printing—using the laws of physics and certain optical properties, to create synthetic materials on the fly with the same digital properties;
Animation—to create realistic garments for animated characters, lending to an even greater degree of realism;
Gaming—realistic fabrics that obey the laws of physics—including being able to simulate bullets or other projectiles going through the material;
Design—scanning fabrics and using them in the design of garments;

Design of military equipment such as bullet-proof vests;
Design of sails for ships to create accurate physics of sails and to determine the tear point and other characteristics;
Spacecraft design—determining properties of fabrics used in solar sails;
Non-destructive art analysis—using optical properties and fabric properties to determine if the artwork is a forgery;
Forensic analysis—doing a deep digital scan of a material to be saved for detailed analysis later on; or
Measure certain aspects of the garment “feel” against a wearer's skin; data useful for determining these may be obtained by using techniques such as ultrasound, air projection etc.
   Example Use Cases in which the Inventive System May Provide Benefits to Users

The inventive system seeks to create a realistic 3D image in real-time or pseudo real-time. One benefit of this is the ability to allow customer digital facsimiles and/or digital facsimiles representing others to be placed into a scene where the customer is at the center of a fully immersive environment, while wearing garments chosen by a retailer or selected by the user. The images are preferably generated in real-time (or pseudo real-time) because the customer makes a choice prior to rendering the image. The image may be used by the merchant or manufacturer to promote a particular item (that may have been generated for that user by a recommendation engine), or by the user to view how they would appear in a particular garment at a particular location or setting,

The following is a list of possible additional use cases or scenarios in which an embodiment of the inventive system and methods may provide benefits to customers, shoppers, merchants, or clothing designers. The list is not intended to be exhaustive, to place constraints on other possible uses, or to represent a required set of uses for an implementation of an embodiment. Note that aspects of these use cases and their interactions with the inventive system or platform have been described previously with reference to FIGS. 4(a), 4(b) and 5.

### Scenario 1

New account flow (an example of the possible flow is illustrated at least in part in FIGS. 4(a) and 4(b)). Note that the next time the user visits the retailer site and clicks on the inventive service's link, they do not have to re-enter their credentials. Note also that multiple retailers can use the same service. A user may maintain one profile that is accessible by any retailer who supports the inventive service platform. The user can also maintain a library of garments/accessories that they have collected by accessing various retailers.

Note also that retailers typically cannot access or see a user's library. The library entry typically contains basic information about the garment, such as Garment UPC Code, Retailer's name, Size, Color, and a link to the 3D reconstruction of the user wearing the garment.

### Scenario 2

A designer/retailer can use the inventive service as part of the design process. In this case, after a designer has assembled a garment/accessory on a CAD system, the designer can “experiment” with the design using the inventive system to see how it will look on a realistic user or on a set of realistic users with different sizes and proportions. A possible workflow for this use case is illustrated in FIG. 5.

### Scenario 3

Using data collected from many different users by the system, a retailer is able to make better decisions in terms of sizing, return policies, colors, and general demographics. The system provides this information to the retailer by anonymizing the data to remove any personal identifiable information.

### Scenario 4

A friend of the user wants to buy a gift for the user—the friend gets the user's digital facsimile data with the user's permission and sees how the garment will look on the user using the inventive system or platform. The friend can purchase the garment and send it to the user.

### Scenario 5

The user can change the hairstyle of the digital facsimile using well known stylist brands, styles, cuts, colors, etc.

### Scenario 6

As the digital facsimile shows the user's color, the user can try makeup, jewelry etc.—also from well-known cosmetic and fashion brands.

### Scenario 7

User can have live chats with friends and shared sessions with friends where their friends can view the digital facsimile wearing the chosen garment/accessories in real-time with the user. Each user is represented by a camera in the virtual retail space and can move around and change angles. Friends can also have a shared VR experience.

### Scenario 8

User can save the session and then send the session to a professional personal shopper/consultant who advises them as to whether or not the outfit looks good, and may suggest a change (to the garment, the size, the color, the accessories, the makeup, the hair style, etc.) which can also be viewed on the digital facsimile.

### Scenario 9

Users see targeted advertisements to pre-fabricated sessions based on the user's tastes. When the user clicks on the advertisements, a session is launched with their digital facsimile wearing the garment in question. This allows a user to obtain a more realistic view of how they would look in a particular garment or accessory.

### Scenario 10

Using the repository of data collected over time, the inventive system can automatically generate outfits and accessories taken from various online stores that the user frequents, and then create a session with the user's digital facsimile and pre-populate the user's account with the session for the user to see at his/her own leisure. Such generated outfits may be the result of selection by a consultant or professional shopper, selections made by members of a social network, may represent sale items, may be the result of recommendations based on collaborative filtering, etc.

### Scenario 11

The user goes somewhere where a high precision scan is made of their body. They can upload the scan into the inventive system for later use in garment shopping.

### Scenario 12

The user initiates a session with the inventive system to try out different hair styles before choosing one.

### Scenario 13

The user creates a session with a given garment or set of garments. The user is able to print/generate the garment at a local garment printing company (typically via a 3D printer or computer driven manufacturing system).

### Scenario 14

A user can record a video or take pictures of their digital facsimile wearing the garment of their choice to post on a social networking site or to send to friends.

### Scenario

A user can use a 3D/RGB-D camera to take a full body image and then upload the full body image to generate a photo-realistic, anatomically correct digital facsimile to use when trying garments, accessories etc.

### Scenario 16

A user can license out their digital facsimile to third parties who support the system's Digital facsimile Engine. The Digital facsimile engine collects data provided to it to create a realistic 3D representation of the user and outputs the digital facsimile in forms that can be manipulated by standard 3D sculpting/design tools.

### Scenario 17

A user can add custom animation to their digital facsimile to make it more realistic, such as simulating breathing, body movements etc.

### Scenario 18

Using a digital facsimile generated by the system, a user can navigate to the NASA site (or another site, such as a vacation site), which supports the inventive service and they can now see their digital facsimile on Mars or some other planet.

### Scenario 19

The user can purchase custom morphs to change their digital facsimile—for example giving their digital facsimile Vulcan or Klingon characteristics.

### Scenario 20

The user can construct clothes within the inventive system and then generate the garment designs for custom manufacturing, or use the system to print out a 3D garment.

### Scenario 21

The user can use their generated digital facsimile on social networking sites.

### Scenario 22

The user can purchase a designer virtual garment for their digital facsimile from a design company. The garment is intended only for their digital facsimile. Fantasy garments such as suits of armor, Klingon clothing, elf dresses, or space marine uniforms can also be created and sold for people's digital facsimiles.

### Scenario 23

The user stores his digital facsimile and then bequeaths the digital facsimile to his next of kin when he passes away as a memory of him.

### Scenario 24

The user purchases pet garments and accessories such as collars. A digital facsimile of the pet is constructed using realistic fur/hair as well as matching the pet's proportions. The image is made using a RGB-D camera and inference based on reflectivity of the coat.

### Scenario 25

The user can purchase custom backgrounds, lighting types etc. For example, the user purchases a Klingon background for use when they are purchasing a Klingon outfit.

### Scenario 26

The user can customize clothes, such as by extending sleeve length, shortening hemlines, etc. using controls found in the inventive system/application.

### Scenario 27

The military can design uniforms, body armor, BDUs etc. using enhanced physics and material physics knowledge stored in the system. The armor/uniforms desired characteristics and shape are entered and the system makes recommendations of materials/fabrics.

### Scenario 28

The military/police can customize body armor to specific sizes and proportions by using the soldier's/policewoman's digital facsimile.

### Scenario 29

The user gives permission to others to view and use their digital facsimile with varying degrees of exposure. The user's friends use the user's digital facsimile session to purchase outfits that the user is more likely to enjoy and also outfits that will fit the user.

### Scenario 30

From its repository of known garments and knowledge of the user's preferences, the inventive system makes recommendations to the user to increase the likelihood of a purchase. The logic of the recommendations may use a Bayesian network to identify conditional probabilities of garment choices.

### Scenario 31

The system may detect that the user is overweight and then starts recommending weight-loss products or promoting gym memberships etc.

### Scenario 32

The system may be used by designers to create conceptual clothes that are highly realistic, using materials and characteristics stored in the system. The system may include a search function that enables the designer to enter a set of garment properties, such as weight, color, whether or not the garment “breathes”, texture, strength etc, and the system can return a range of materials that meet their needs.

### Scenario 33

The system may include the ability to apply models of age or weight progression to a user's digital facsimile to generate alternative depictions for the user based on changes to weight, skin tone, skin surface, etc.

### Scenario 34

A customer provides images of them wearing the garment—these are digitized/processed to provide comparison between the service's “prediction” of what the garment would look like on the customer and what it actually looks like—this information is used to refine or modify the model inputs when they are applied to that customer.

### Scenario 35

A customer's model inputs/parameters may be used to identify brands/styles, etc. that may fit or look the best by comparing that customer's model inputs to those of a standardized customer or brand of garment example having a particular size, body shape, etc.

### Scenario 36

A user scans in an image of a desired hairstyle which is then displayed on their digital facsimile, along with desired changes to length, color, etc.

### Scenario 37

As the digital facsimile is so rich, and the physical rigging matches the human it is supposed to reflect, it can be used to identify people as an added benefit and thus be used as part of a security system.

Integration with Vendor's Website

One of the features of the inventive service platform is the ability to integrate with a partner site (e.g., retailer) in a relatively simple and easy manner. Conventionally, other sites that have some level of integration require placing an iFrame on the partner web site that links to their own website and passes parameters such as size and retailer D. Note that this prevents the retailer from truly integrating the fitting process into their workflow and they depend on the “fitting room's” website. This means that if the retailer wants to build a more transparent workflow for the user, then the retailer either has to ask the virtual fitting room provider to custom build a website (which delays deployment, or may not even work), or abandon the idea.

For example: assume that Felicity is a developer working for an online fashion retailer. She is annoyed with the operation of typical virtual fitting rooms that either take too much time or effort to integrate, don't give her much control, or force her to choose all or nothing. But in contrast, an embodiment of the inventive system provides her with a programmatic interface that allows her to create innovative shopping tools of her own, such as a tool she calls “FlipMode”. With FlipMode, a customer can click on the stock image of a model wearing a garment which then “flips” the image around to show the customer's digital facsimile wearing the same garment. This provides an easy way for a customer to visualize themselves in the selected article of apparel without further interactions with the system.

As noted, embodiments of the inventive system and methods provide benefits and advantages to both shoppers and vendors in part because of the ease with which it may be integrated into the vendor's existing eCommerce system or platform. This provides a more holistic and complete experience for a shopper, while enabling the services provided by the inventive system to be made more readily available by a vendor. And, as also noted the integration with the vendor's website enables the vendor to introduce custom or personalized workflows for specific shoppers or categories of shoppers.

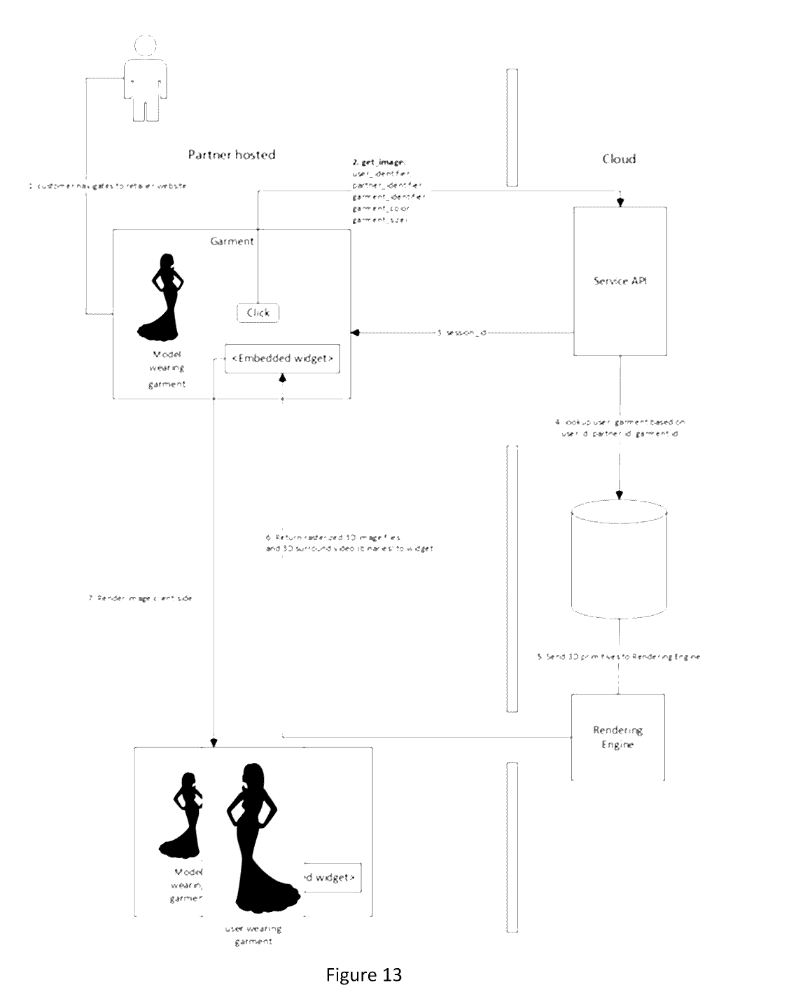

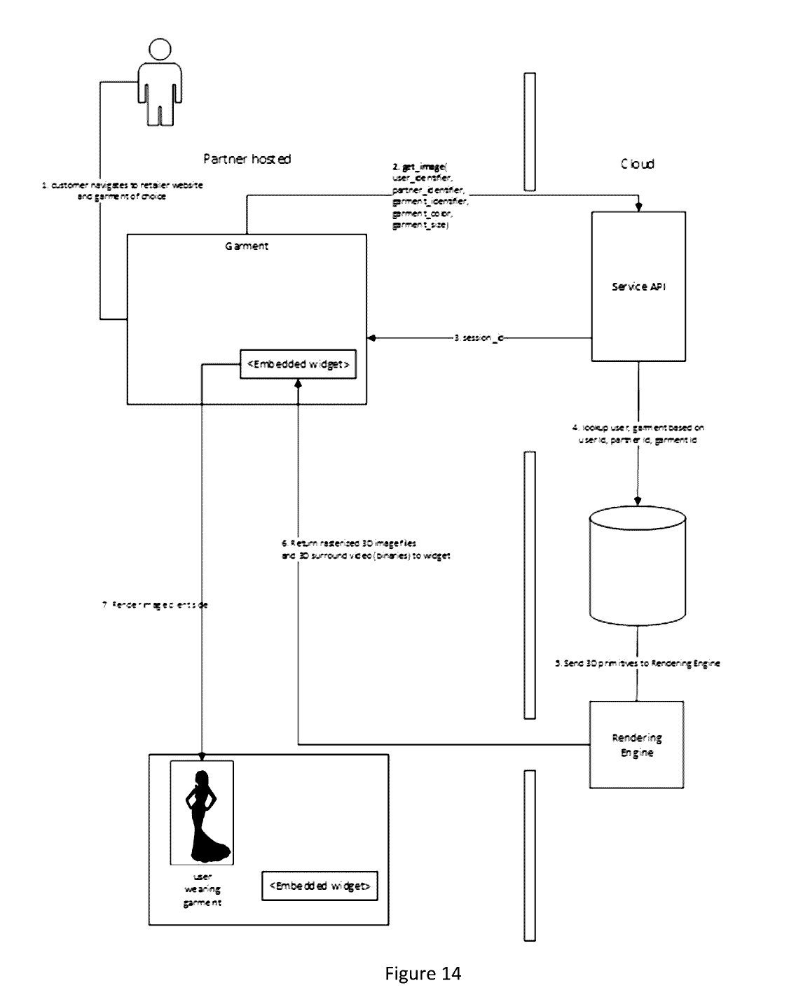

In some embodiments, there are at least three possible integration models or approaches:
Active integration model (described with reference to FIG. 13);
Passive integration model (described with reference to FIG. 14); or
Design integration model (described after FIGS. 13 and 14).

FIG. 13 is a diagram illustrating a first example of the integration of the inventive system with a retailer or vendor website. As shown in the figure, in this implementation, a user may interact with an embodiment of the inventive system and methods by executing or participating in the following steps, stages, or operations:
1. User navigates to Retailer/Partner site;
2. User navigates to a garment on the Partner site (where an image of a model wearing the garment may be shown—when the user selects that garment, data is passed to the Service Platform, typically via a suitable API—this establishes a user session with the Service Platform);
3. The user session results in the Service Platform accessing data or data structures that can be used to characterize the garment and/or user from a suitable database or data storage element—this data is then used to generate one or more of an digital facsimile representing the user, a representation of the garment, or a representation of the digital facsimile wearing the garment under one or more environmental conditions or in one or more locations (typically by use of a suitable rendering engine);
3. User clicks on a button associated with an embedded widget;
4. A popup window opens;
5. User sees themselves in the garment in the popup window—they may be able to vary certain of the environmental aspects, such as wind, rain, lighting or location; and
6. If desired, the User purchases the garment by initiating a purchase transaction.

FIG. 14 is a diagram illustrating a second example of the integration of the inventive system with a retailer or vendor website. As shown in the figure, in this implementation, a user may interact with an embodiment of the inventive system and methods by executing or participating in the following steps, stages, or operations:
1. User navigates to Retailer/Partner site—User creates an account on the Partner site;
2. User navigates to a garment on the Partner site (user indicates that they would like to see themselves in the garment instead of viewing it on a model—when the user selects that garment, data is passed to the Service Platform, typically via a suitable API—this establishes a user session with the Service Platform);
3. The user session results in the Service Platform accessing data or data structures that can be used to characterize the garment and/or user from a suitable database or data storage element—this data is then used to generate one or more of a digital facsimile representing the user, a representation of the garment, or a representation of the digital facsimile wearing the garment under one or more environmental conditions or in one or more locations (typically by use of a suitable rendering engine);
4. Instead of seeing a photo of a model wearing the dress, the user sees herself wearing the dress without the use of a popup window—the user may be able to vary certain of the environmental aspects, such as wind, rain, lighting or location; and
5. If desired, the User purchases the garment by initiating a purchase transaction

As noted, in addition to the passive or active integration forms, there is also a design integration model or architecture:
1. The designer uses a plugin for his CAD tool;
2. The garment properties are gathered—seam, design and fabric;
3. A lookup is made in a database of pre-scanned materials and the garment is created virtually, including if desired buttons, seams, and other structural features;
4. The garment image/model is highly accurate because the constituent models are based on actual fabric or material characteristics and responses to applied forces, etc.; and
5. The designer can “test” the garment on a variety of body shapes taken from a database.

Note that while in some embodiments, the UI that is used to access the inventive system may be customizable for the retailer, in other embodiments, a set of web APIs (e.g., REST based) may be provided that will allow the retailer to set up their own workflow. This may be used to permit a retailer/designer to interact with a customer in a desired order and/or to capture certain data or other inputs as part of establishing an account, generating the digital facsimile and garments, etc.

For example, the retailer could ask the user to set up their digital facsimile at the point the user creates an account for the retailer or store. Creating the digital facsimile would make a call to the system's API that sends secure data related to the user. The system then generates a digital facsimile for that user that is linked to the retailer account. When the customer goes to a garment that he/she wants to try out, the retailer shows the digital facsimile of the user wearing the garment instead of another person (such as a fashion model). The retailer does this by making a web service call to the service platform sending the UPC code and the retailer user ID, and the platform performs a lookup and generates a 3D view of the user digital facsimile wearing the garment. The view is of a container that is hosted in an iframe that's owned by the service platform. This is a “white label” version or implementation of the inventive system.

The following is a non-exhaustive list of example APIs (Application Programming Interfaces) that may be enabled or provided by an embodiment of the inventive system and methods. In some embodiments, the inventive system can provide the Partner/Retailer/etc. with a set of API calls for one or more of:
Creating a customer account associated with the Service Platform;
Generating a customer digital facsimile; or
Assigning garments to the digital facsimile and viewing the digital facsimile wearing the garments under one or more environmental conditions.

In these or other use cases, a possible set of APIs may include one or more of:

### Fitting

Create a customer digital facsimile and assign it to a given user id
   This returns a handle to the digital facsimile in the form of a unique identifier
   The customer can in theory use the digital facsimile for many other purposes if they have the unique identifier
Modify the user digital facsimile based on inputs:
   Structures that include tailor measurements, size information, skin tone, skin markings, face structure, etc.
Delete the user digital facsimile using the unique identifier
Request images and animations based on:
   Customer ID
   Garment UPC code or set of codes for creating an ensemble (e.g. shirt, trousers, shoes)
   Garment color
   Garment size
Request that a given fitting session be stored for later recall
   A fitting session consists of a customer assigning a garment or set of garments (as part of an ensemble) to their digital facsimile
Sending the fitting session to friends via email or social networking
Requesting a VR version of the fitting session
Requesting a handle to the fitting session (i.e., a session identifier)
Modifying a fitting session

### Onboarding Garments

Uploading the garment:
   Base geometry
   Material zones
   Colors
   Sizes
   Material set
   UPC code
Modifying the garment
Search for the garment
Delete the garment

### Onboarding Materials

Load material
   Material name
   Material properties (e.g., the set of material properties listed below)
      Stress/Strain tensor
      Channel (RGB) reflection, diffusion, diffraction, transmission, refraction
      “Roughness” index measured by the piezoelectric scanner
      Normal map
      Warp factor (amount the material sags measured by the curvature of the sag)
      Material density (wave propagation velocity at different frequencies)
      Material dampening (attenuation of wave amplitude over the distance of the material)
Modify material
Delete material
   In this embodiment of the service platform, a user may be provided with a “widget” that the partner/retailer embeds in their website. The widget contains the basic information needed to display the customer digital facsimile wearing the garment, providing a VR experience, and/or showing a 3D animation of the customer with the garment on. The widget may be customized by the partner/retailer so that it has the look and feel of the partner/retailer branding elements, etc.

### Example Rendering Pipeline

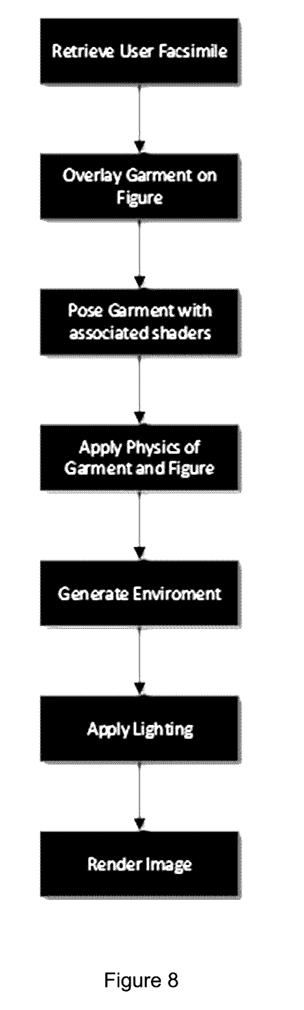

FIG. 8 is a diagram illustrating an example of a rendering pipeline or operations flow that may be used when implementing an embodiment of the inventive system and methods. As shown in the figure, in this example a user facsimile, digital facsimile or model is accessed from a data storage element (as suggested by step or stage 802). A visualization of the selected garment is then overlaid on the user visualization (as suggested by step or stage 804). The figure wearing the garment is then posed or arranged and subject to the appropriate shading (as suggested by step or stage 806). The appropriate models or representations of the behavior of the garment and its appearance under different conditions are then applied (as suggested by step or stage 808). The surrounding environment in which the user representation and garment will be viewed is then generated (this may include the ability to represent the environmental conditions, scenery, location, etc.), as suggested by step or stage 810. The desired lighting, perspective, wind, etc. is then applied to the images (as suggested by step or stage 812). After that, the final image or images are rendered by a suitable rendering engine (as suggested by step or stage 814).

Note that the system may accelerate the rendering of realistic images by performing all (or substantially all) rendering “in the cloud” where it can be allocated a relatively large amount of computational power. In some embodiments, the inventive system may generate images (jpegs, gifs, etc.) and video files (mp4, mov, etc.) so that the system may use a simple WebGL widget on the client side to display the results to the user.

In addition to applying computational power, the system may include plugins for commercial rendering engines to perform tasks such as preloading generic objects or pre-calculating light diffusion on skin with various skin tones and lighting conditions.

Using these pre-calculated values, the system may then use linear transformations to orient the normal maps and occlusion. Because the system is used to render very similar objects, there is scope for reuse, which simplifies the overall rendering process.

In some embodiments, as soon as a new garment is “scanned in”, the system may pre-compute animation characteristics so that they do not require re-calculation during an animation. This is possible and efficient because the system uses the same sets of animations repeatedly; the primary changes are the garment type, body type and facial features. The system may pre-compute the body type of the digital facsimile, the garment physics, the material shader(s) of the garment, and the human skin shader(s); the system may use a modified physics engine that computes the soft-body to soft-body interaction of the garment with the digital facsimile flesh and then use a fast rendering engine to output a photo.

### Example of Method to Develop Body Model

Note that a user doesn't need to use any special equipment (such as scanners, image capturing devices, or measuring devices) to generate the digital facsimile or digital facsimile. Instead, the inventive system is able to generate a 3D reconstruction of the user based on a limited set of data, for example, sex, height, weight, age, and skin tone. The 3D reconstruction is a first approximation using the average of human bodies that have been scanned using precision scanning technologies. If a user is dissatisfied with the resulting representation, they can modify it using additional details, such as:
Build (Petite, Slim, Athletic, Muscular, heavyset, curvy, few extra pounds, big and beautiful, pear shaped)—these may be presented as icons for ease of selection;
Bra size (S, M, L);
Blouse size (S, M, L);
Skirt Size (S, M, L);
Shirt size (S, M, L);
Pant size (S, M, L); or
Jacket size (S, M, L).

Based on a range of body shapes from the general population, the system can compute the 3D optical flow from body elements to go from one body endpoint to another. For example, if there is a reference body shape A and a reference body shape B corresponding to some set of measurements, then the system can identify a set of standard points on the bodies and compute the optical flow going from A to B. This means that if the user picks a body size between A & B, then the system can compute the optical flow from A to B which allows the system to interpolate the body shape to a new shape A′. The reference bodies are categorized according to BMI and some basic body shape guidance from the user (as a high BMI could either indicate a heavyset person or a heavily muscled person). The body guidance may be expressed as the build or as a graphic that indicates a general shape or structure, such as triangle, pear, apple, hourglass, rectangular, etc. With the height, BMI and shape as a reference point, the system then retrieves the closest 3D references A & B (in this example) and then computes the optical flow from A to B to return the corresponding 3D body model.

By constructing a physical body model, the system can alter the rigging by re-computing the center of mass of the body using a standard approach and by inferring the masses of various components of the body. The system may use a simple human model with appropriately distributed density to compute the center of mass based on distance from a fixed point on the body. Based on this and the articulation of the body, the system can infer a bone model. Determining the center of mass, hip and pelvis width, pelvis to knee length and knee to feet measurement, the system can estimate/determine the person's gait, which can then be used as part of the construction of the digital facsimile/animation.

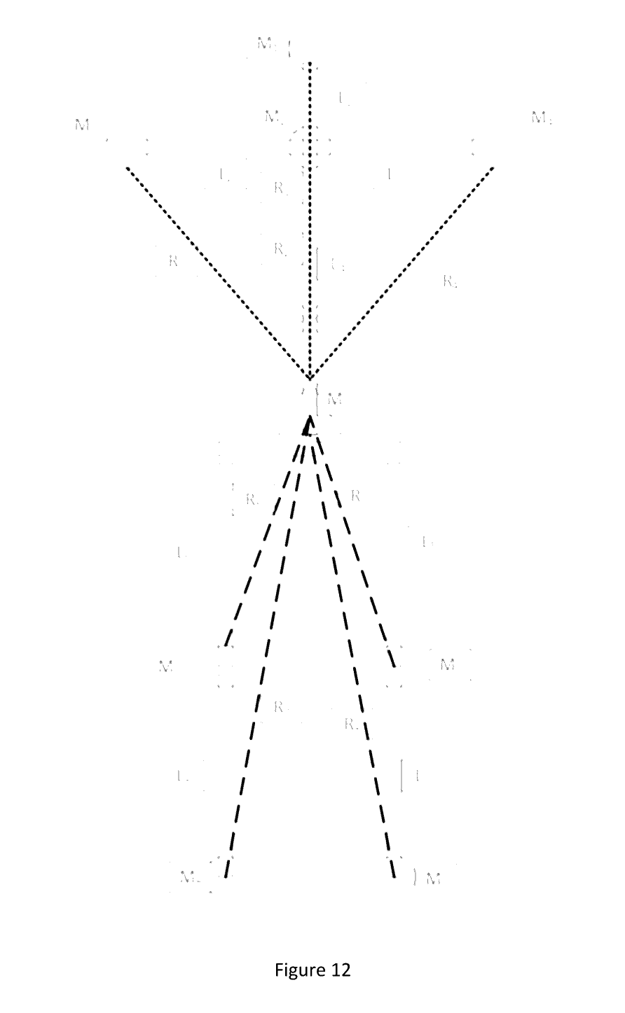

In one implementation (as illustrated in FIG. 12), the system operates to divide up a body model based on density zones and then determine masses for various points by integrating over the density zones. The system can then determine a reference point and calculate the center of mass of all the point masses based on the distance from the reference point by taking the Cartesian distance. For example, as suggested by the figure, a person's body may be represented by a set of masses (illustrated by the masses Mᵢ, located at positions which are a distance Rᵢ from a global or local center of mass.

These measurements are converted into a standard measure using an appropriate algorithm, and then a 3D figure is rendered that has the user's general appearance. The user can choose to take pictures of his/her face and upload them to the website, which will then do a 3D reconstruction of their face. In this case the system generally uses 3 pictures—front, left profile and right profile. The frontal shot provides the z-projection of the face. The left and right profile allow generation of an edge map using a standard edge mapping algorithm; this allows the system to determine the 3D relief face structure from a generic face.

In some cases, a reference database of male or female faces corresponding to age may be used to assist in this process. Based on the sex and age, the system can select the appropriate face and then morph the face so that 2 conditions are met—the z-projection matches the morphed face and the edge profile matches the captured profile. The system may select several reference points to compute the optical flow (e.g., nose tip, jaw edge, nose-bridge, lip, chin, etc.) and operates to interpolate the face. The user may be asked to select a rough skin tone; the system then maps the skin tone to a realistic skin shader. The system may match details from the face (e.g., beard, birthmark, etc.) and add the face details to the generic skin shader to compute an accurate skin shader. The resulting 3D figure will then have a close approximation to the user's face and body (or general body type).

The selected garment is then draped on the generated figure in a way that is realistic and based on the behavior of the material/cloth (as possibly determined by use of the scanner or material characterization system described herein). Next time the user clicks on the button to view the digital facsimile/3D figure, they do not have to go through the process again if they have remained logged on. If the user goes to another retailer that uses the inventive service, then the user can use their existing account with the service so that they don't have to enter the data again.

The garment designer (or a retailer or other party) may assemble/define/design the garment using a CAD based tool, which includes information about the size, material, and color. A 3D representation is created and stored in a standard format (e.g., wavefront .obj files). The fabric may be modeled using an algorithm that can assign properties to the fabric to give it the appearance and behavior of a range of realistic materials (silk, cotton, linen, etc.). The fabric model is applied to the virtual garment so that it has the look and expected behavior of the real counterpart. Draping rules may be applied with smoothing and collision algorithms to prevent “poke through”. The draping physics may take into consideration the dynamics of the garment as well as gravity, wind, and other forces that might be applied to the garment.

The inventive service may store a library of virtual garments as well as the digital facsimiles of users of the service. Note that the database of garments and digital facsimiles can be repurposed for other uses, including digital/video gaming and social media. For example, the realistic digital facsimiles may be imported into a gaming environment so that a user can interact with that environment using a more realistic visualization of themselves or themselves wearing a specific garment. Similarly, the realistic digital facsimiles may be imported into a social media network so that the user's communications are associated with their digital facsimile, their digital facsimile wearing a specific garment is able to be visualized by members of the user's network, etc.

As described herein, embodiments of the inventive system and methods may provide one or more of the following benefits and advantages:
a) Integration with the retailer's website—driven from the Retailer's site and not a standalone system;
b) Workflow can be initiated with a relatively small/minimum of data (such as BMI and age)—this enables calculation of a first approximation figure, based on an algorithm that utilizes base models calculated from human forms;
c) Enables a retailer to customize the workflow before exposing their web services (this may be of value to a Retailer wishing to provide the user with value-adds or a specific sequence of interactions that are intended to increase conversion rates, upsell services or products, facilitate a purchase transaction, etc.);
d) Digital facsimile bodies are more realistic;
e) Can personalize by adding a face or an image of the user's face;
f) Material/cloth behavior (draping, falling, movement, etc.) based on physical principles and models, and therefore is more accurate and realistic, and not generic;
g) Reflective properties of light from material/cloth/seams are more realistic (e.g., shiny, matte, etc.);
h) Hair on digital facsimiles behaves more naturally with regards to movement and light reflection (again, based on physics models);
i) System is capable of simulating different lighting conditions (daylight, dusk, overcast, bright sun, etc.);
j) Certain customization/personalization may be utilized to enhance the accuracy and realism of the digital facsimile. These may include one or more of
   skin tone, skin surface smoothness, skin mottling, etc.; and/or
   effects of weight or weight distribution on the appearance of clothing or accessories;
k) A session may be saved and stored for later sharing or use;
l) System may interact with and collect data regarding multiple retailer sites and user interactions with the inventive service platform—this can be used to gather business intelligence regarding desirable styles, sizing, aggregate inventory levels, aggregate conversion rates, potential changes to the workflow, etc.;
m) System is capable of providing suggestions for or depicting accessories, such as suggested or typical user make-up (based on a desired manufacturer or shade), shoes, jewelry, hair color, hair style, etc.; and
n) System is a capable of generating a virtual reality environment and user experience (may assist in depicting appearance as viewed by others, permit contests between groups of users in costumes or settings, visualization of groups together in a setting, etc.).

The inventive system seeks to create a realistic 3D image in real-time or pseudo real-time. One benefit of this is the ability to allow customer digital facsimiles and/or digital facsimiles representing others to be placed into a scene where the customer is at the center of a fully immersive environment, while wearing garments chosen by a retailer or selected by the user. The images are preferably generated in real-time (or pseudo real-time) because the customer makes a garment or accessory choice prior to rendering the image. The image may be used by the merchant or manufacturer to promote a particular item (that may have been generated for that user by a recommendation engine), or by the user to view how they would appear in a particular garment at a particular location or setting.

As described, embodiments of the invention provide a system and process that is expected to reduce the return rate for online garment/apparel/accessory retailers. The invention can be integrated with any existing website. In a typical session, when the user navigates to the retailer's site, the user chooses an item of clothing. The user activates a button that launches a second screen. If the user has previously registered with the inventive service, then the user is taken to a screen that allows the user to see a realistic 3D representation of themselves wearing the garment, where the garment behaves like the real item of apparel. A user can contact a friend who can log in from a mobile device or other device to see how the garment looks on the user, and help the user to decide whether to purchase the garment and/or accessories. A user can also post a link to the user digital facsimile on a social networking site so that her online friends can see the garment as well.

Further examples of use cases or situations in which the inventive system and methods may have value include:
1. A customer wants to go on vacation. They pick a location and render themselves in that location in a relatively small amount of time. The resulting image shows them at that location (e.g., a beach) under realistic lighting;
2. A customer wants to see themselves in a trendy lounge. They choose a lounge and the resulting image is rendered showing them in the lounge environment and under realistic lighting; or
3. A customer goes shopping. She chooses a sports outfit and she wants to see how she looks while jogging in a forest.
   As a result, the customer feels more emotionally engaged with the product and is more likely to want to make a purchase. Marketers can use this to give the user more targeted advertisements that are more likely to result in a purchase.

Embodiments of the inventive system and methods may include one or more of the following features, services, capabilities and functions and associated advantages and benefits:
1. A novel retail experience for the customer by enabling them to see a highly realistic representation of themselves wearing a garment that is physically accurate in a realistic environment under realistic lighting conditions in real-time;
2. A VR representation of the above in animated form;
3. API based integration model that allows retailers to use complex rendering and analysis services in their applications/web sites in an easy way;
4. Single click representation of the user wearing a chosen garment (click on the retailer's website);
5. Ability to scan a garment and produce parameters to generate a highly realistic garment;
6. A novel garment design process;
7. A decision making analysis based on data collected on preferences, ages, etc.; or
8. A personal shopper scenario, where a trusted third party can review choices and make recommendations of ensembles etc.

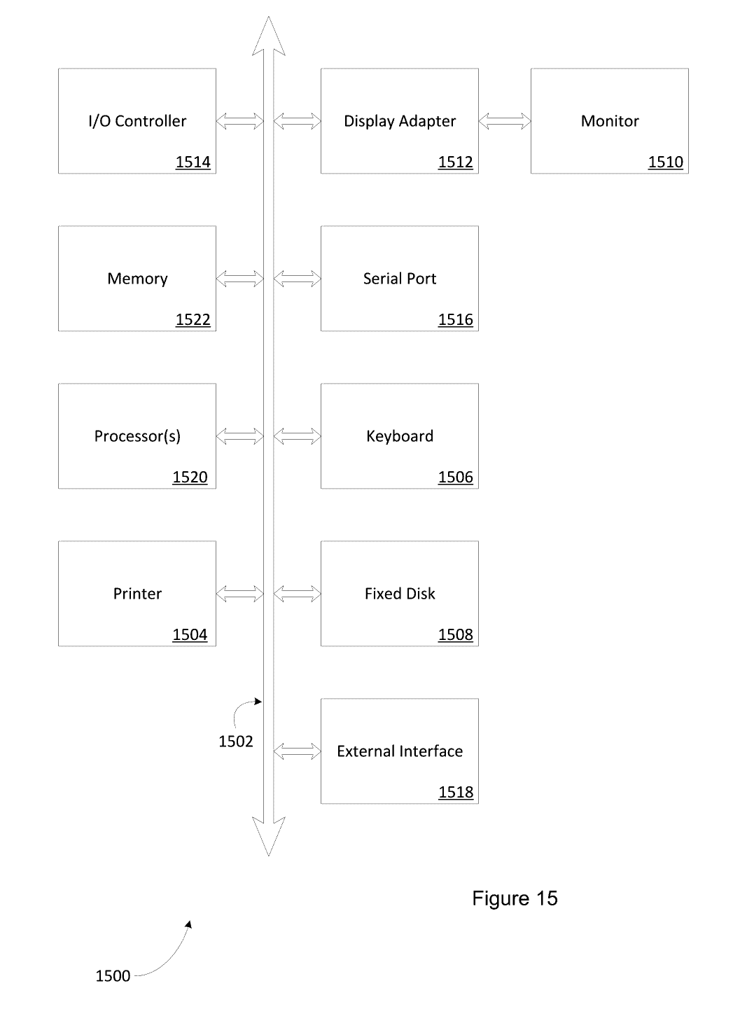

FIG. 15 is a diagram illustrating elements or components that may be present in a computer device or system configured to implement a method, process, function, or operation in accordance with an embodiment of the invention. As noted, in some embodiments, the inventive system and methods may be implemented in the form of an apparatus that includes a processing element and set of executable instructions. The executable instructions may be part of a software application and arranged into a software architecture. In general, an embodiment of the invention may be implemented using a set of software instructions that are designed to be executed by a suitably programmed processing element (such as a CPU, microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform. Each application module or sub-module may correspond to a particular function, method, process, or operation that is implemented by the module or sub-module. Such function, method, process, or operation may include those used to implement one or more aspects of the inventive system and methods.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

As described, the system, apparatus, methods, processes, functions, and/or operations for implementing an embodiment of the invention may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 15 is a diagram illustrating elements or components that may be present in a computer device or system 1500 configured to implement a method, process, function, or operation in accordance with an embodiment of the invention. The subsystems shown in FIG. 15 are interconnected via a system bus 1502. Additional subsystems include a printer 1504, a keyboard 1506, a fixed disk 1508, and a monitor 1510, which is coupled to a display adapter 1512. Peripherals and input/output (I/O) devices, which couple to an I/O controller 1514, can be connected to the computer system by any number of means known in the art, such as a serial port 1516. For example, the serial port 1516 or an external interface 1518 can be utilized to connect the computer device 1500 to further devices and/or systems not shown in FIG. 15 including a wide area network such as the Internet, a mouse input device, and/or a scanner. The interconnection via the system bus 1502 allows one or more processors 1520 to communicate with each subsystem and to control the execution of instructions that may be stored in a system memory 1522 and/or the fixed disk 1508, as well as the exchange of information between subsystems. The system memory 1522 and/or the fixed disk 1508 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, Javascript, C++, or Perl using conventional or object-oriented techniques. The software code may be stored as a series of instructions, or commands on a computer readable medium, such as a random access memory (RAM), a read only memory (ROM), a magnetic medium such as a flash-drive, hard-drive or floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A system for generating a visualization of a shopper wearing a garment, comprising:
an electronic commerce platform operated for the benefit of a source of a plurality of items of apparel, wherein the electronic commerce platform includes elements configured to
generate a user interface for use by the shopper, the user interface including a selectable element which, when selected or activated, initiates a process coupling the electronic commerce platform to a visualization service platform; and
provide access to an electronic catalog or other set of data describing the plurality of items of apparel;
a visualization service platform, wherein the visualization service platform includes elements or processes configured to
authenticate the shopper;
access data describing the shopper;
if necessary, request data describing the shopper;
receive data identifying an item of apparel from the electronic commerce platform;
in response to receiving the data identifying the item of apparel, access data describing the material from which the item is constructed and the structural elements of the item of apparel;
generate an electronic representation of the item of apparel;
generate an electronic representation of the shopper wearing the item of apparel;
generate a visualization of the shopper wearing the item of apparel;
present the visualization of the shopper wearing the item of apparel to the shopper;
receive an input from the shopper identifying a change to the environmental conditions associated with the visualization of the shopper wearing the item of apparel; and
re-generate the visualization of the shopper wearing the item of apparel in the changed environmental conditions.

2. The system of claim 1, wherein the data describing the shopper that is accessed or requested includes one or more of BMI, age, height, or weight.

3. The system of claim 1, wherein the process coupling the electronic commerce platform to the visualization service platform further comprises a process to provide access to one or more databases or data storage elements, wherein the one or more databases or data storage elements contain data regarding the item of apparel, the material from which the item of apparel is constructed, or the shopper's physical characteristics.

4. The system of claim 1, wherein accessing data describing the material from which the item is constructed and the structural elements of the item of apparel further comprises collecting data regarding the material or materials from which the item of apparel is constructed using a device that measures a response of the material or materials to an applied force or the appearance of the material or materials under a source of illumination.

5. The system of claim 1, wherein the change to the environmental conditions associated with the visualization of the shopper wearing the item of apparel includes one or more of a change to lighting, wind, or rain conditions, or a change to the location.

6. The system of claim 1, further comprising an element or a process to permit the shopper to initiate a purchase transaction for the item of apparel.

7. The system of claim 1, further comprising an element or a process to enable the shopper to obtain a recommendation for an accessory to wear with the item of apparel.

8. The system of claim 1, further comprising an element or a process to enable the shopper to share the visualization of the shopper wearing the item of apparel with one or more members of a social network of which the shopper is a member.

9. A method of enabling a shopper to conduct a purchase transaction for an item of apparel, comprising:
providing a computer implemented process to enable the shopper to select the item of apparel;
providing a computer implemented process to access data regarding the item of apparel from an electronic data storage element, wherein the data regarding the item of apparel includes data that represents the response of a material from which the item of apparel is at least partially constructed to an applied force or data that represents the appearance of a material from which the item of apparel is at least partially constructed in response to a source of illumination;
providing a computer implemented process to enable the shopper to construct a visualization of the shopper based on physical characteristics of the shopper;
generating a visualization of the shopper wearing the item of apparel;
displaying the visualization to the shopper;
enabling the shopper to vary one or more environmental conditions related to the visualization;
generating a new visualization of the shopper wearing the item of apparel under the environmental conditions as varied by the shopper;
providing a computer implemented process to enable the shopper to indicate a desire to purchase the item of apparel; and
executing a computer implemented process to enable the shopper to initiate a transaction to purchase the item of apparel.

10. The method of claim 9, further comprising a computer implemented process to provide the shopper with a recommendation of an accessory to wear with the item of apparel.

11. The method of claim 9, further comprising a computer implemented process to enable the shopper to share the visualization of the shopper wearing the item of apparel with one or more members of a social network of which the shopper is a member.

12. The method of claim 9, wherein the process for generating the visualization of the shopper wearing the item of apparel further comprises generating data describing the material from which the item is constructed and the structural elements of the item of apparel.

13. The method of claim 12, wherein generating data describing the material from which the item is constructed and the structural elements of the item of apparel further comprises collecting data regarding the material or materials from which the item of apparel is constructed using a device that measures a response of the material or materials to an applied force or the appearance of the material or materials under a source of illumination.

14. The method of claim 9, wherein the environmental conditions that may be varied by the shopper include one or more of lighting, location, wind, or rain.

15. The method of claim 9, wherein the computer implemented process to enable the shopper to construct a visualization of the shopper based on physical characteristics of the shopper further comprises a process to enable the shopper to access or provide data regarding the shopper's appearance or characteristics.

16. The method of claim 15, wherein the data regarding the shopper that is accessed or provided includes one or more of BMI, age, height, or weight.

17. An apparatus for generating a visualization of a shopper wearing an item of apparel, comprising:
a set of computer-executable instructions stored in an electronic data storage element;
an electronic processing element, wherein when executed by the processing element, the set of instructions cause the apparatus to
enable a shopper to select an item of apparel from a plurality of items of apparel;
access data regarding the selected item of apparel, wherein the data regarding the selected item of apparel includes data that represents the response of a material from which the item of apparel is at least partially constructed to an applied force or data that represents the appearance of a material from which the item of apparel is at least partially constructed in response to a source of illumination;
enable the shopper to construct a visualization of the shopper based on physical characteristics of the shopper;
generate a visualization of the shopper wearing the item of apparel;
cause the visualization to be displayed to the shopper;
enable the shopper to vary one or more environmental conditions related to the visualization; and
generate a new visualization of the shopper wearing the item of apparel under the environmental conditions as varied by the shopper.

18. The apparatus of claim 17, wherein the set of instructions also include instructions which when executed by the processing element cause the apparatus to
enable the shopper to indicate a desire to purchase the item of apparel; and
enable the shopper to initiate a transaction to purchase the item of apparel.

19. The apparatus of claim 17, wherein the set of instructions also include instructions which when executed by the processing element cause the apparatus to
provide the shopper with a recommendation of an accessory to wear with the item of apparel.

20. The apparatus of claim 17, wherein the one or more environmental conditions that may be carried by the shopper include the lighting, location, wind, or rain related to the visualization.

21. The apparatus of claim 17, wherein the set of instructions also include instructions which when executed by the processing element cause the apparatus to
enable the shopper to share the visualization of the shopper wearing the item of apparel with one or more members of a social network of which the shopper is a member.

22. The apparatus of claim 17, wherein the physical characteristics of the shopper include one or more of BMI, age, height, or weight.
